(19) United States
(12) Patent Application Publication
(10) Pub. No.: US 2017/0316807 A1
(43) Pub. Date: Nov. 2, 2017

(54) SYSTEMS AND METHODS FOR CREATING WHITEBOARD ANIMATION VIDEOS

(71) Applicant: Squigl LLC, Wilmington, DE (US)

(72) Inventors: Eric Herkert-Oakland, Fitchburg, WI (US); Odeh A. Muhawesh, Plymouth, MN (US)

(21) Appl. No.: 15/373,809

(22) Filed: Dec. 9, 2016

Related U.S. Application Data
(60) Provisional application No. 62/266,300, filed on Dec. 11, 2015.

(51) Int. Cl. G11B 27/031; G06F 3/0484; G06T 13/80; G06F 17/21

(52) U.S. Cl. CPC G11B 27/031; G06T 13/80; G06F 3/0484; G06F 17/211

(57) ABSTRACT

Whiteboard messaging is a form of communication that may be particularly effective in conveying a message to one or more individuals or groups. In a method for creating a whiteboard animation video having glyphs and voice, an intended audience for the video is determined, and text including information to be conveyed by the video is received. The text is converted to a story that includes a narration to be provided in the video. On ore more keywords from the story are determined, and one or more glyphs are assigned to each keyword. A voice for narrating the story is determined, and the video is produced.

### CROSS-REFERENCE TO RELATED APPLICATION

The present application is based on and claims the benefit of U.S. provisional patent application Ser. No. 62/266,300, filed Dec. 11, 2015, the content of which is hereby incorporated by reference in its entirety.

### BACKGROUND

There are a variety of ways to convey a message using technology. One might use text, audio, or other means to convey a message to one or more individuals or groups. However, conventional forms of conveying a message, such as through e-mail for example, may not effectively and/or powerfully convey the intended message. Behavioral psychology, neuroscience, and other research suggest that individuals are more likely to respond to and retain information presented in particular forms. For example, audio and visual stimulation combined into a single message format may provide for a particularly effective messaging format. In addition, a message communication that is engaging may hold a recipient's attention more effectively than other formats.

### SUMMARY

Whiteboard messaging is a form of communication that may be particularly effective in conveying a message to one or more individuals or groups. Whiteboard messaging may include the use of animated drawings, sound, and/or text to create a whiteboard animation video. The cost to produce a conventional whiteboard animation video can be high, because each video may generally be produced individually for each application. Conventionally, the production of whiteboard animation videos may also be particularly time consuming, as each video generally may be produced in isolation, such that each animation, text, and voice component may be created individually for each video produced. In this way, methods and systems for conventional whiteboard animation videos may lack scalability.

Thus, a need exists for a scalable whiteboard animation application that may cost-effectively, efficiently, and relatively quickly produce a finished whiteboard animation video message directed to one or more targeted audiences. A further need exists for an automated, or partially automated computer-implemented method for creating a targeted whiteboard video message for a targeted audience that is culturally specific and in the language of the intended audience, without the creator needing to understand what cultural differences are relevant and without needing to know the language of the intended recipient. A further need exists for a whiteboard animation video application whereby a creator can provide inputs for one message that may then be adapted by the present system for one or more additional audiences, whereby the system adapts the message to be culturally appropriate and in the correct language for the one or more additional audiences.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1A is a screenshot of a hand holding a writing utensil in order to draw a glyph, according to some embodiments.

FIG. 1B is a screenshot of a glyph, according to some embodiments.

FIG. 2 is a process for creation a whiteboard animation video, according to some embodiments.

FIG. 3 is a system for creating a whiteboard animation video, according to some embodiments.

FIG. 4 is a method for creating a whiteboard animation video, according to some embodiments.

FIG. 5 is a system for creating a glyph, according to some embodiments.

FIG. 6A is a draw space of a glyph creation user interface, according to some embodiments.

FIG. 6B is an add keywords space of a glyph creation user interface, according to some embodiments.

FIG. 6C is a draw space of a glyph creation user interface, according to some embodiments.

FIG. 7 is a login screen for a user interface, according to some embodiments. As shown, the login screen may require a username and/or password in order to provide access to various levels of access.

FIG. 8 is a video library screen of the user interface, according to some embodiments. From the video library screen, a user may see videos available to view, past created videos, and/or other videos including, for example, instructional videos. From the video library screen, a user may have the option to start creation of a new whiteboard animation video.

FIG. 9 is a script entry screen of the user interface, according to some embodiments. From the script entry screen, a user may create a script by typing or recording the script. A user may import the script in some embodiments. FIG. 9 may be a story entry screen or a text entry screen according to other embodiments.

FIG. 10 is the script entry screen of FIG. 9, with the addition of a portion of a script typed, recorded, or input by a user.

FIG. 11 is a glyph selection screen of the user interface, according to some embodiments. Glyphs may be automatically or manually selected based on keywords of the script. Keywords may also be selected manually or automatically. The glyph selection screen may allow a user to view a combined video of the glyphs selected for the keywords. FIG. 11 may be a video editing screen, according to some embodiments, where a user may edit the script, keywords, audio, glyphs, and/or other aspects of the whiteboard animation video.

FIG. 12 is the glyph selection screen of FIG. 11, showing a still shot of the combined video of selected glyphs. As shown, an associated keyword or keywords may be highlighted when the corresponding glyph plays in the video. FIG. 12 shows a still shot of the glyph associated with keyword “hello” playing while “hello” is highlighted in the script. “Hello” may also be concurrently heard in the video. FIG. 12 may be a video editing screen, according to some embodiments, where a user may edit the script, keywords, audio, glyphs, and/or other aspects of the whiteboard animation video.

FIG. 13 is the glyph selection screen of FIG. 11, showing a still shot of the combined video of selected glyphs. FIG. 13 shows a still shot of the glyph associated with keyword “core” playing while “core” is highlighted in the script. “Core” may also be concurrently heard in the video. FIG. 13 may be a video editing screen, according to some embodiments, where a user may edit the script, keywords audio, glyphs, and/or other aspects of the whiteboard animation video.

FIG. 14 is a combine glyphs and audio screen of the user interface, according to some embodiments, where a user may combine selected glyphs with audio of the script, story, or other audio for the animation video. FIG. 14 shows a still shot of the video of combined glyphs and audio. FIG. 14 further illustrates the glyph associated with keyword “anyone” playing while “anyone” is highlighted in the script. “Anyone” may also be concurrently heard in the video. FIG. 14 may be a video editing screen, according to some embodiments, where a user may edit the script, keywords, audio, glyphs, and/or other aspects of the whiteboard animation video.

FIG. 15 is a glyph search result screen of the user interface, according to some embodiments, where a search result related to a particular keyword of the script or other search may be seen. FIG. 15 shows search results for glyphs related to the keyword “swarming” from the script. The user may use the search result screen to replace a previously selected glyph or to select an additional glyph to add to the video, for example. FIG. 15 shows a glyph selected to be associated with the keyword “swarming” from the script. FIG. 15 may be a glyph search screen, according to some embodiments, where a user may search for a glyph to associate with a keyword. For example, a user may select a keyword of the script and search for glyphs in the glyph database related to that keyword. A user may also conduct additional glyph searches from this screen in some embodiments.

FIG. 16 is the glyph search result screen of FIG. 15, showing a different glyph from the search result selected to be associated with keyword “swarming” from the script.

FIG. 17 is a glyph search result screen of the user interface, according to some embodiments, where a search result related to a particular keyword of the script or other search may be seen. FIG. 17 shows search results for glyphs related to the keyword “accomplish” from the script. The user may use the search result screen to replace a previously selected glyph or to select an additional glyph to add to the video, for example. FIG. 17 shows a glyph selected to be associated with the keyword “accomplish” from the script. FIG. 17 may be a glyph search screen, according to some embodiments, where a user may search for a glyph to associate with a keyword. For example, a user may select a keyword of the script and search for glyphs in the glyph database related to that keyword. A user may also conduct additional glyph searches from this screen in some embodiments.

FIG. 18 is a glyph search result screen of the user interface, according to some embodiments, where a search result related to a particular keyword of the script or other search may be seen. Related words for each glyph of the search result may be viewable on the glyph search result screen. A user may select a related word for a glyph to conduct a new glyph search based on the related word. The glyph search result screen may allow a user to conduct a new search, for example, by typing in a word or words to search for glyphs. FIG. 18 may be a glyph search screen, according to some embodiments, where a user may search for glyphs by typing in a word or words.

FIG. 19 is a glyph search result screen of the user interface, according to some embodiments, where a search result related to a keyword or other word or words searched may be seen. FIG. 19 shows search results for glyphs related to the word “achievement.” The user may use the search result screen to replace a previously selected glyph or to select an additional glyph to add to the video, for example. FIG. 19 may be a glyph search screen, according to some embodiments, where a user may search for a glyph to associate with a keyword. For example, a user may select a keyword of the script and search for glyphs in the glyph database related to that keyword. A user may also conduct additional glyph searches from this screen in some embodiments.

FIG. 20 is the glyph search result screen of FIG. 19, showing a glyph from the search result selected to be associated with the keyword “accomplish” from the script.

FIG. 21 is the glyph selection screen of FIG. 11, with some of the selected glyphs having been replaced by different glyphs.

FIG. 22 is a record script screen of the user interface, according to some embodiments, where a user may create or import an audio recording of a voice reading the script for the animation video. In some embodiments, the user may record his or her own voice reading the script.

FIG. 23 is a help screen of the user interface, according to some embodiments, where a user may find technical support or system support contact information and/or may ask questions. A help screen may be a popup or other screen that opens within the user interface. The help screen may open when a user clicks a help, contact us, or other button of the user interface.

FIG. 24 is the record script screen of FIG. 22, with the addition of a 21 second audio recording having been recorded.

FIG. 25 is the combine glyphs and audio screen of FIG. 14. FIG. 25 may be a video editing screen, according to some embodiments, where a user may edit the script, keywords, audio, glyphs, and/or other aspects of the whiteboard animation video.

FIG. 26 is the combine glyphs and audio screen of FIG. 25, showing a still shot of the video of combined glyphs and audio. FIG. 26 further illustrates the glyph associated with keyword “hello” playing while “hello” is highlighted in the script. “Hello” may also be concurrently heard in the video. FIG. 26 may be a video editing screen, according to some embodiments, where a user may edit the script, keywords, audio, glyphs, and/or other aspects of the whiteboard animation video.

FIG. 27 is the combine glyphs and audio screen of FIG. 25, showing a stills hot of the video of combined glyphs and audio. FIG. 27 further illustrates the glyphs associated with keyword “swarming” playing while “swarming” is highlighted in the script. “Swarming” may also be concurrently heard in the vide. FIG. 27 may be a video editing screen, according to some embodiments, where a user may edit the script, keywords, audio, glyphs, and/or other aspects of the whiteboard animation video.

FIG. 28 is the combine glyphs and audio screen of FIG. 25, showing an option for deleting a glyph from the video. FIG. 28 may be a video editing screen, according to some embodiments, where a user may edit the script, keywords, audio, glyphs, and/or other aspects of the whiteboard animation video.

FIG. 29 is the combine glyphs and audio screen of FIG. 25, showing a space where a glyph was deleted from the video. FIG. 29 may be a video editing screen, according to some embodiments, where a user may edit the script, keywords, audio, glyphs, and/or other aspects of the whiteboard animation video.

FIG. 30 is the combine glyphs and audio screen of FIG. 29, showing a glyph selected. A glyph may be selected and moved to a different time or location within the video. FIG. 30 may be a video editing screen, according to some embodiments, where a user may edit the script, keywords, audio, glyphs, and/or other aspects of the whiteboard animation video.

FIG. 31 is the combine glyphs and audio screen of FIG. 29, showing the glyph selected in FIG. 30 having been relocated to a new time or location within the video. FIG. 31 may be a video editing screen, according to some embodiments, where a user may edit the script, keywords, audio, glyphs, and/or other aspects of the whiteboard animation video.

FIG. 32 is the video library screen of FIG. 8, with the addition of a whiteboard animation video created by the user accessible from the video library screen. From the video library screen, a user may see videos available to view, past created videos, and/or other videos including, for example, instructional videos. From the video library screen, a user may have the option to start creation of a new whiteboard animation video.

FIG. 33 is the video library screen of FIG. 32, with the addition of an upgrade screen, according to some embodiments. An upgrade screen may remind a user of the user's limited license or access capabilities, for example, and may provide the user with an option to upgrade to a different license or access level.

FIG. 34 is a glyph selection screen of the user interface, according to some embodiments. Glyphs may be automatically or manually selected based on keywords of the script. Keywords may also be selected manually or automatically. The glyph selection screen may allow a user to view a combined video of the glyphs selected for the keywords. FIG. 34 shows a still shot of the glyph associated with keyword “big” playing while “big” is highlighted in the script. “Big” may also be concurrently heard in the video. FIG. 34 may be a video editing screen, according to some embodiments, where a user may edit the script, keywords, audio, glyphs, and/or other aspects of the whiteboard animation video.

FIG. 35 is a glyph selection screen of the user interface, according to some embodiments. Glyphs may be automatically or manually selected based on keywords of the script. Keywords may also be selected manually or automatically. The glyph selection screen may allow a user to view a combined video of the glyphs selected for the keywords. FIG. 35 may be a video editing screen, according to some embodiments, where a user may edit the script, keywords, audio, glyphs, and/or other aspects of the whiteboard animation video.

FIG. 36 is a glyph selection screen of the user interface, according to some embodiments. Glyphs may be automatically or manually selected based on keywords of the script. Keywords may also be selected manually or automatically. The glyph selection screen may allow a user to view a combined video of the glyphs selected for the keywords. FIG. 36 may be a video editing screen, according to some embodiments, where a user may edit the script, keywords, audio, glyphs, and/or other aspects of the whiteboard animation video.

### DETAILED DESCRIPTION OF ILLUSTRATIVE EMBODIMENTS

The present disclosure relates to systems and methods for whiteboard messaging. Particularly, the present disclosure relates to systems and methods for providing a whiteboard messaging platform, whereby users can create narrow, focused, and highly effective whiteboard animation videos. The systems and methods of the present disclosure may generally provide for scalable creation of whiteboard animation videos directed to one or more targeted audiences. The present disclosure further relates to efficient and effective systems and methods for developing culturally unique and sensitive whiteboard animation videos. The present disclosure further relates to systems and methods for producing whiteboard animation videos such that individual components of the videos may be saved, stored, edited and/or reused in future applications that allows for efficient and relatively quick and cost-effective video production.

A whiteboard animation video may be useful for disseminating any type of information such as providing information related to marketing, advertising, training, testing, educating, or any other information. In its final form, a whiteboard animation video may generally be a video that shows a hand drawing images on a surface, such as but not limited to, a whiteboard marker surface. In some cases, text and/or a voice and/or music, etc. may accompany the drawings. The text or voice may generally provide the information that the video is intended to convey to the viewers, while the hand may draw particular images that relate to the message of the text or voice. For example, a whiteboard animation video may be used to instruct viewers how to safely exit a building in the case of an emergency. At least one portion of the video may show a video of a hand drawing, using a marker or other instrument, an image of an elevator and an image of stairs. The hand may further draw an ‘X’ over the elevator and draw a person walking down the stairs. While the hand is drawing these images on the video, a voice may be heard on the video explaining that viewers should take the stairs to exit the building in case of a fire or other emergency and that people should not take the elevator. It may be appreciated that a whiteboard animation video directed toward safely exiting a building may use other images and/or descriptions additionally or alternatively.

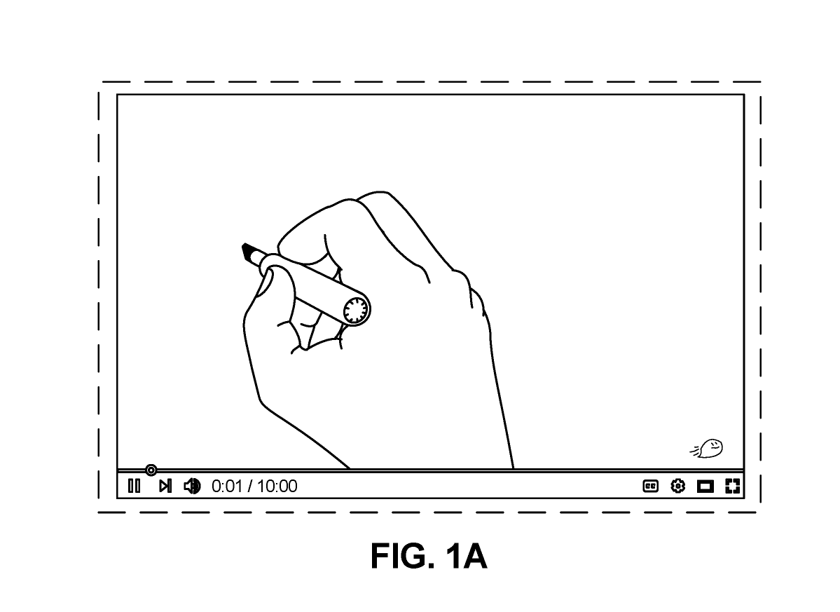

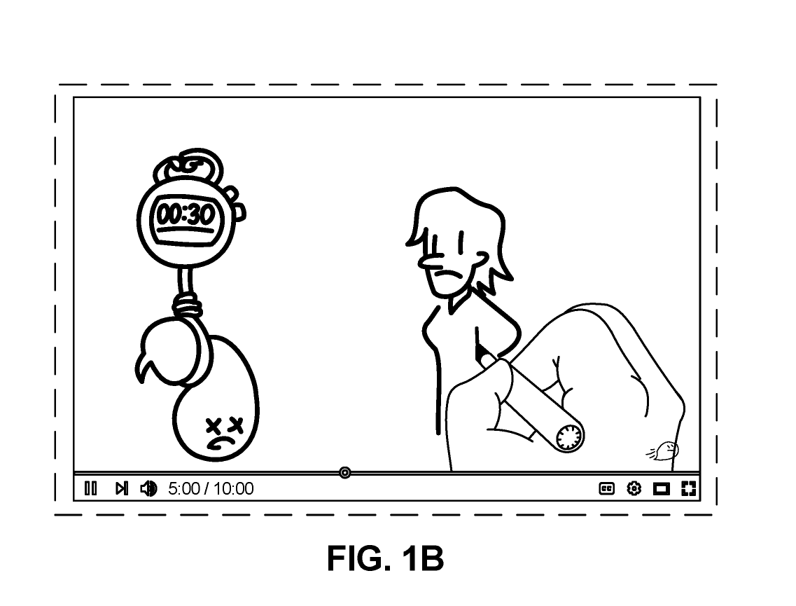

The animated drawings in a whiteboard animation video of the present disclosure may include one or more glyphs. In some embodiments, a glyph may be an animation, movement, or motion of an image or a portion of an image being drawn, as presented in a video format. For example, in some embodiments, a glyph may include an animated hand drawing an image with an animated writing instrument. In some embodiments, a glyph may include a video recording of a hand drawing an image with a writing instrument. For example, FIG. 1A shows a still shot of a video where a hand can be seen drawing a glyph. In some embodiments, the glyph may include the writing instrument without the hand. The hand may have different characteristics depending on different applications. For example, the hand may have generally any skin color, may be presented as a masculine or feminine hand, and/or may represent a person of a particular age in some embodiments. In other embodiments, the hand may be depicted with other features, or may be an animal's paw, for example. Additionally, the writing instrument videoed or animated may generally be any suitable writing instrument, such as but not limited to, a pen, pencil, marker, highlighter, eraser, wand or other writing instrument. Similarly, the writing instrument may generally be and write in any suitable color or combination of colors. A glyph may depict the motion of the writing instrument and/or hand drawing a line, curve, text, or a combination thereof. For example, FIG. 1B shows a still shot of a video where a hand is in the process of drawing a glyph. The background on which the glyphs are drawn may be a white marker board in some embodiments. In other embodiments, the background may appear as a blackboard, a piece of paper, or any suitable background surface of any color. The background may be a picture or video.

Multiple glyphs may be combined to form an image or multiple images, as shown in FIG. 1B, with each glyph drawing a portion of the image. A series of individual glyphs may be combined together, along with sound and/or text to create a whiteboard animation video of the present disclosure. In some cases, a single glyph may form a complete image.

It may be appreciated that a glyph may be drawn or depicted in a variety of ways. For example, a glyph may be drawn from left to right or from right to left, top to bottom, or bottom to top. A glyph may be drawn at various speeds. A hand may be depicted as holding a pen at various angles or positions. In other embodiments, other characteristics of how a glyph may be drawn may differ. Behavioral psychology, neuroscience, and other research suggest that viewers may generally respond to some characteristics of a glyph better or more effectively than others. Furthermore, particular groups of viewers or types of viewers may respond to some glyph characteristics differently than others. Still further, the content of the message may dictate the appropriateness of a particular glyph. For example, a glyph associated with the keyword “stay” may be needed. If the video relates to dog training, the glyph selected by the system as appropriate may show a dog stopping quickly and sitting. Alternatively, if the video is a legal video discussing a stay of court proceedings, the appropriate glyph selected by the system may include a courtroom door with a lock on it, for example. In this way, it may be appreciated that a whiteboard animation video of the present disclosure may be tailored for a particular target audience relating to specific content and based on the use of particular glyphs that may be appropriate for, or more effectively communicate with, the target audience.

Whiteboard Animation Video Creation

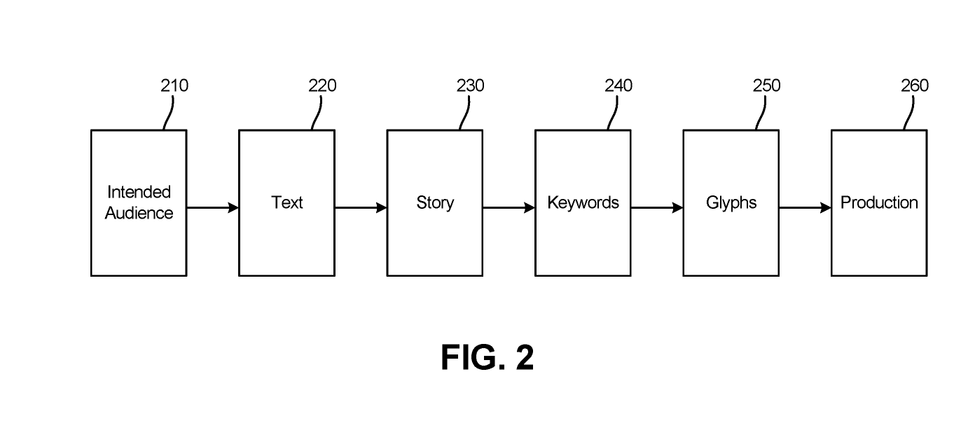

Turning now to FIG. 2, a whiteboard animation video of the present disclosure may be configured for an intended audience 210, and may include selection of text 220, from which a story 230 is created, based upon the selection of keywords 240, and glyphs 250 that illustrate the concept of the selected keywords 240, in order to produce the video 260 via one or more systems or methods of the present disclosure.

The intended audience 210 may be the group of viewers to which the video may be shown or for whom the video may be created. The intended audience 210 may be defined by various characteristics, such as language, geographic location, age, gender, education level, profession, or other characteristics. For example, a particular whiteboard animation video may be intended for an audience of individuals in China who speak Chinese, are generally between the ages of 25 and 55 and whose average education level is the equivalent of a high school diploma. The characteristics of the intended audience 210 may be provided to the system by a user of the system or another source, or may be gleaned or automatically determined by the system from preset or predetermined characteristics in some embodiments. The characteristics of the intended audience 210 may factor into the selections made for text 220, story 230, keywords 240, and glyphs 250. For example, a glyph related to a particular concept may be relevant for an audience of 10-15-year-olds, but may not be as effective with an audience of 60-75-year-olds. In this way, the characteristics of the intended audience 210 may govern or at least influence each element of the video.

The text 220 may define or relate to a message, instructions, or other information that may be conveyed using the whiteboard animation video. The text 220 may be a script or a portion of a script that may be narrated during the video in some embodiments. In other embodiments, the text 220 may be a concept or idea that may be conveyed using the video. For example, in some embodiments, the text 220 may be a single sentence or word. In other embodiments, the text 220 may relate in other ways to the message, instructions, or other information that may be conveyed using the video. The text 220 may generally be written, audio, or a combination thereof. The text 220 may be provided to the system by a user of the system or other source. In some embodiments, the text 220 may be determined automatically or partially automatically. The text may be created by or using the system in some embodiments. For example, a user may use the system to draft or record the text 220. In other embodiments, the text 220 may be created, determined, or provided in other ways.

The story 230 may define or relate to the voice and animations that may be presented in the whiteboard animation video. In some embodiments, the story 230 may be a script or a portion of a script that may be heard during the video. The story 230 may be or may be based on the text 220. In some embodiments, the text 220 may be converted into the story 230 by the system to maximize the impact of the final message based on the content of the text and/or the intended audience. The story 230 may be provided to the system by a user or other source in some embodiments. In other embodiments, the story 230 may be determined automatically or partially automatically by the system. In still other embodiments, the story 230 may be created by or using the system. For example, a user may use the system to draft or record the story 230. In other embodiments, the story 230 may be created, determined, or provided in other ways.

One or more keywords 240 may be selected based on the story 230 and/or text 220. The selection of keywords may be a critical component of some embodiments of the present invention. Because glyphs are associated with some or all of the selected keywords, the impact of the video may be directly correlated to the keywords selected. Selection of inappropriate keywords may diminish or even severely diminish the effectiveness of the final message. Keywords 240 may be particular words or phrases within the story 230 or text 220 or that relate to the story 230 or text 220. Keywords 240 may be nouns, verbs, or words or groups of words. For example, some keywords in a whiteboard animation video about safely exiting a building in the event of an emergency may be “elevator,” “stairs.” Keywords 240 may be pulled directly from the story 230 or text in some embodiments. The system may select keywords automatically or partially automatically. One of the novel features of the present invention includes the highly specific and directed selection of keywords based on the content of the message; for example is the message about a legal concept or is it about dog training. The present invention may also select keywords from the text or story based on the cultural aspects of the intended recipient to most effectively deliver the final message. Keyword selection by the present system may be performed by one or more software algorithms. In some embodiments, the algorithms follow a number of different rules. For example, in some cases, the system may determine that for every five words, one glyph will be shown. Though the system may determine that some other combination of keywords/glyphs is appropriate. In some embodiments, the algorithm would scan a sentence from the text and/or story and identify the various parts of speech, nouns, verbs, adjectives, adverbs etc. In some cases, the system may identify nouns as the most important and/or to be handled first because they are the subject of the sentence. The system may then provide the user with the top three glyphs for the selected noun, and so on. In some embodiments, other parts of speech may be given more weight, for example where the culture of the intended audience for example may respond better.

In some embodiments, the keyword selection algorithm(s) further look for more context such as the subject matter of the text and/or story. The system may identify an adjective associated with the selected noun and perform a search for glyphs that are tagged with both the noun and the adjective. For example, a sentence may contain the noun ‘hearted’ and could pull up a glyph tagged with the keyword ‘hearted,’ but the adjective ‘warm’ or ‘cold’ in the sentence would determine the final glyph(s) suggested. The adjective gives the noun context.

The system in some embodiments may also find verbs in the sentence and identify one or more glyphs that are tagged with both the noun and verb. For example, a sentence may contain the noun ‘ball.’ The system may identify a glyph resembling any number of sports related balls. However, if the sentence also contains the word ‘kick,’ for example, the system may narrow the identified glyphs down to some images of a foot kicking a soccer ball because it has both the ‘soccer’ and ‘kick’ tags. The verb gives the noun context, and vice versa. In some embodiments, when the noun ‘ball’ is mentioned later in the script, the system may prioritize the use of soccer glyphs. The selected glyphs give the rest of the script context.

Keywords may be selected by a user in some embodiments. In some embodiments, the system may determine a list of keywords and provide the list to a user for approval.

One, more, or all selected keywords 240 may be used to search for one or more relevant glyphs 250 to be associated with the keywords and shown in the whiteboard animation video. The glyphs 250 may be chosen by searching a database of glyphs as part of the system and method of the present disclosure. In other embodiments, the glyphs 250 may be selected by other means, by a user or automatically or partially automatically by the system. When a glyph 250 is associated with a keyword 240 of the video, the glyph may be depicted on the video when the keyword is read or discussed or otherwise referenced during the video. For example, where a whiteboard animation video directed toward instructions for safely exiting a building in the event of an emergency has the keywords “elevator” and “stairs,” those keywords may be used to search for relevant glyphs to depict in the video. The keyword “elevator” may return a glyph of a hand drawing an elevator, and likewise, the keyword “stairs” may return a glyph of a hand drawing a set of stairs. In the portion of the instructional video where a voice informs viewers to take the stairs in case of an emergency, the elevator and stairs glyphs may be depicted in the video. The software algorithm(s) in some embodiments may identify the most appropriate glyph to present to the user based on, for example, the popularity of the glyph/keyword association as maintained in the glyph database (discussed in greater detail below). The glyph database may be or may include a crowd sourced platform that allows one or more communities to define what image best describes a given keyword.

The intended audience 210, text 220, story 230, keywords 240, and glyphs 250 may be used to produce 260 a whiteboard animation video of the present disclosure. Production of the video may be completed by or using a system of the present disclosure. The system may produce the video automatically or partially automatically in some embodiments. For example, after each of the elements 210-250 has been determined, the system may automatically return a completed whiteboard animation video with voiceover and relevant glyphs. In other embodiments, a user may manually produce the video using the system.

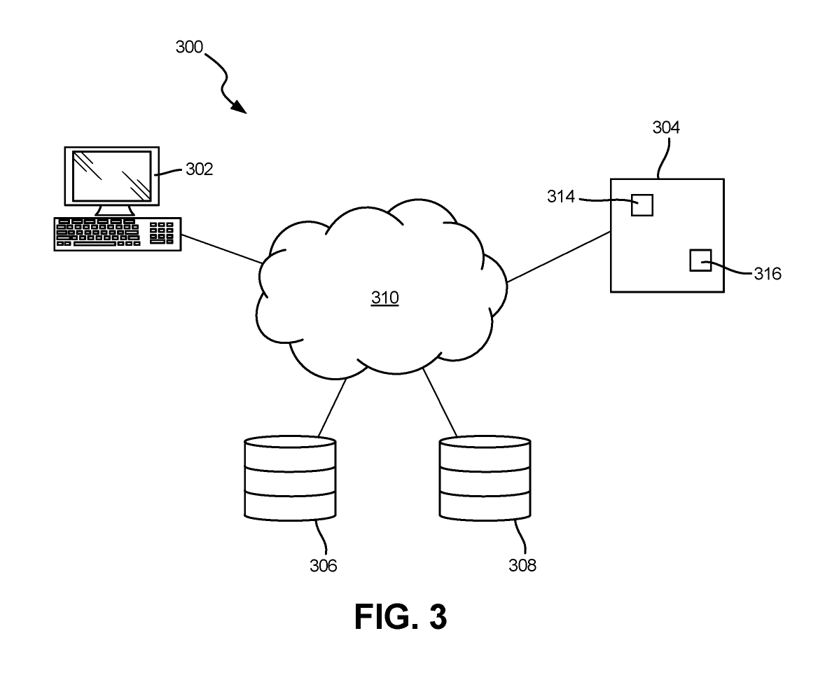

Turning now to FIG. 3, whiteboard animation video creation system 300 of the present disclosure may include a user interface 302, a whiteboard animation module 304, a glyph database 306, and one or more additional databases 308 in wired or wireless communication over a network 310. The system 300 may allow a user to create a narrow, focused, and highly effective whiteboard animation video tailored for one or more particular targeted audiences.

As shown in FIG. 3, the system may have a user interface 302 that allows a user to access and interact with the whiteboard animation module 304, glyph database 306, and one or more additional databases 308. The user interface 302 may be a web-based user interface in some embodiments. In some embodiments, the user interface 302 may be or include an application, such as a computer application or smartphone application. The user interface 302 may be available over one or more computing devices, such as a desktop computer, notebook computer, smartphone, tablet computer, PDA, or other device. In some embodiments, the user interface 302 may require a user login, such as a username and/or password. In some embodiments, the username and/or password may relate to a user's unique user profile on the user interface 302, for example. The user profile may include information related to the person or the company a person works for, for example. In this way specific information may be associated with the profile in the system that may be used by the system to generate an automated whiteboard video from relatively little user input. For example, a user profile may include the language of the person, the profession of the person, the hobbies of the person, and/or any other defining characteristics of the person etc. In some embodiments, a company profile may also be saved in the system that may be associated with information about the company. The information about the company may be provided by the user or may be automatically generated by the system from publicly available sources. The profile information may be verified and/or edited by one or more entities or by the system itself. In some cases, the user may verify, edit, or add to the profile, while in other embodiments, a system administrator may verify, edit, add or remove information. In other embodiments, a combination of one or more entities may have access to the information or access to edit the information in a user profile.

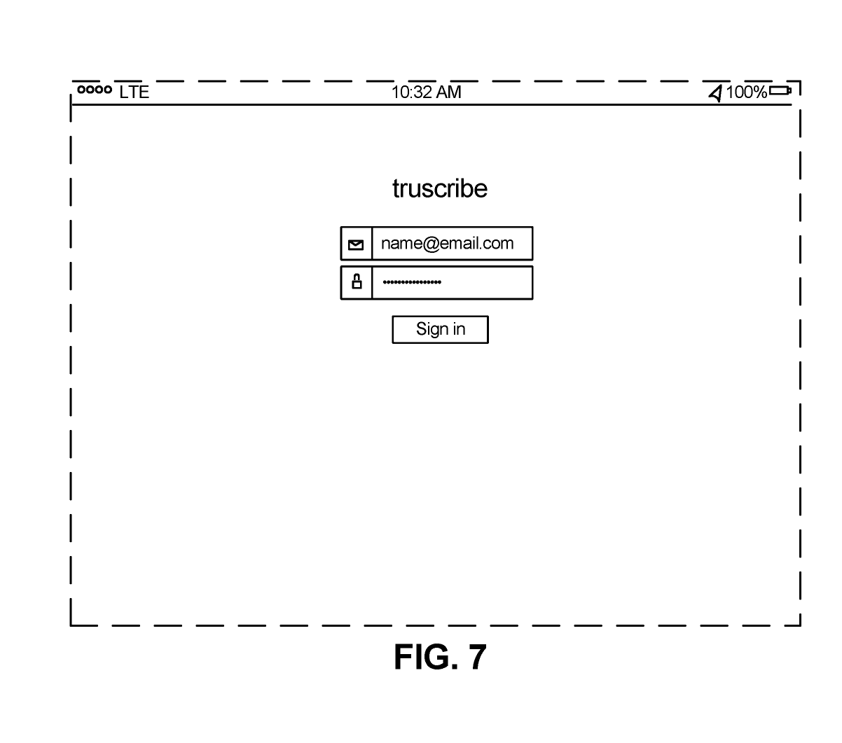

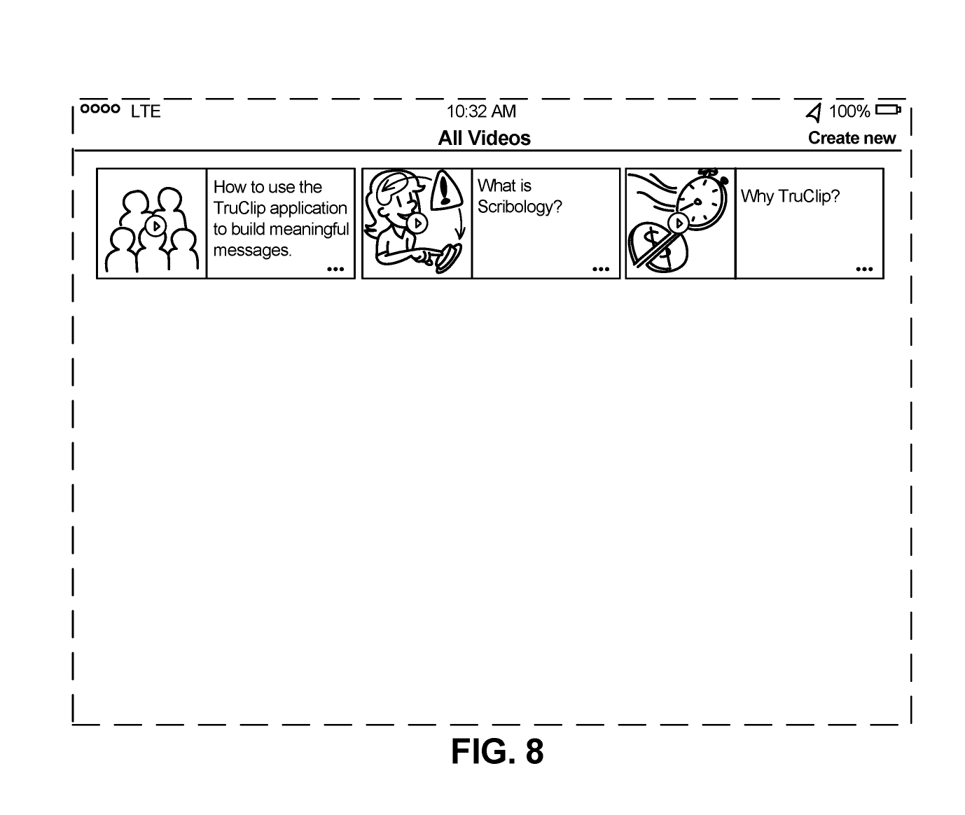

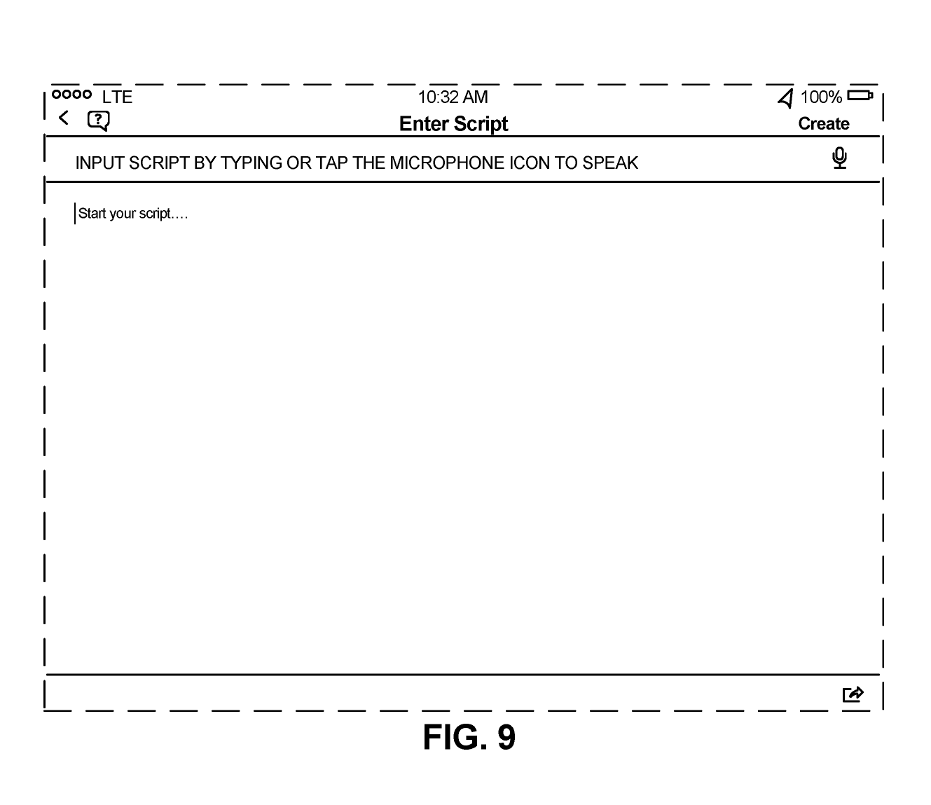

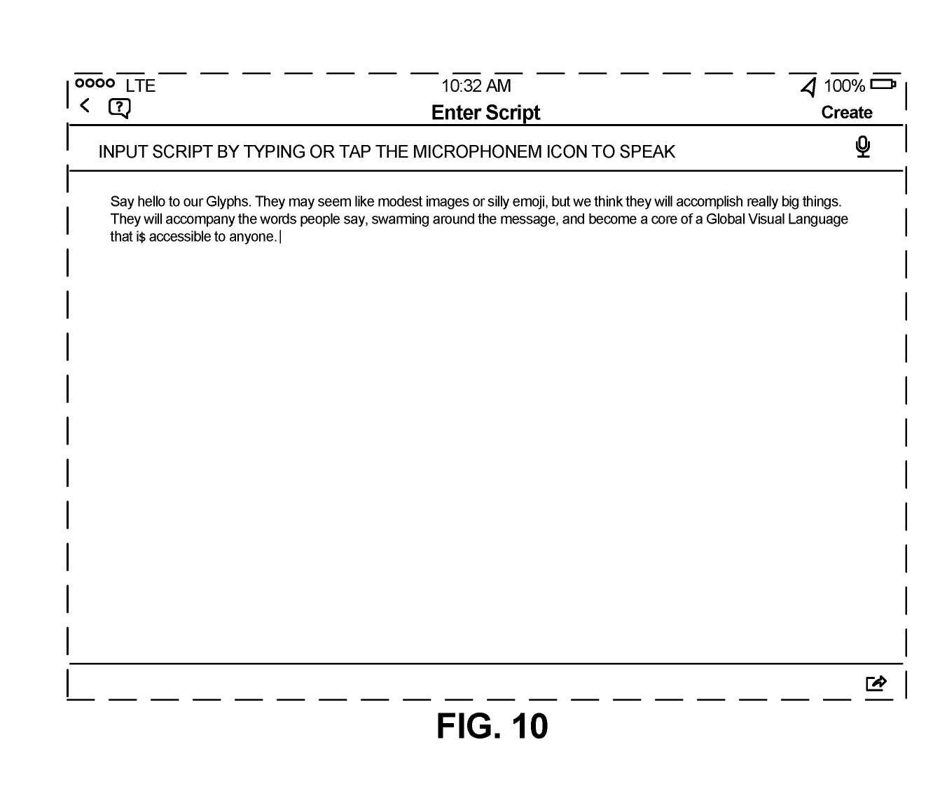

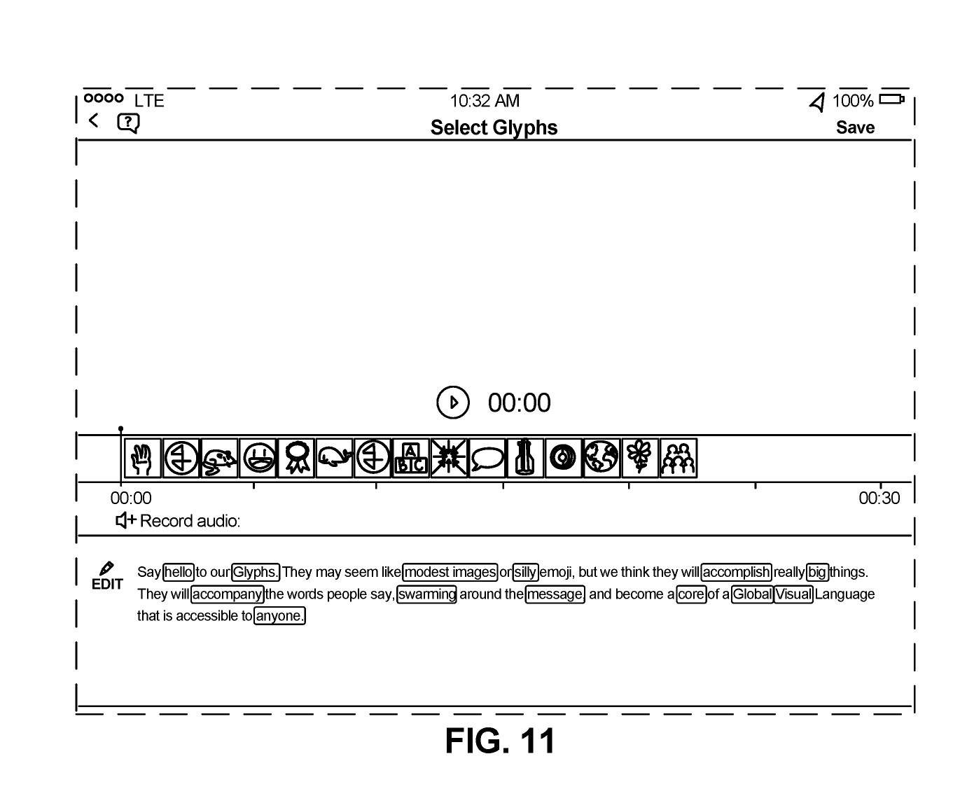

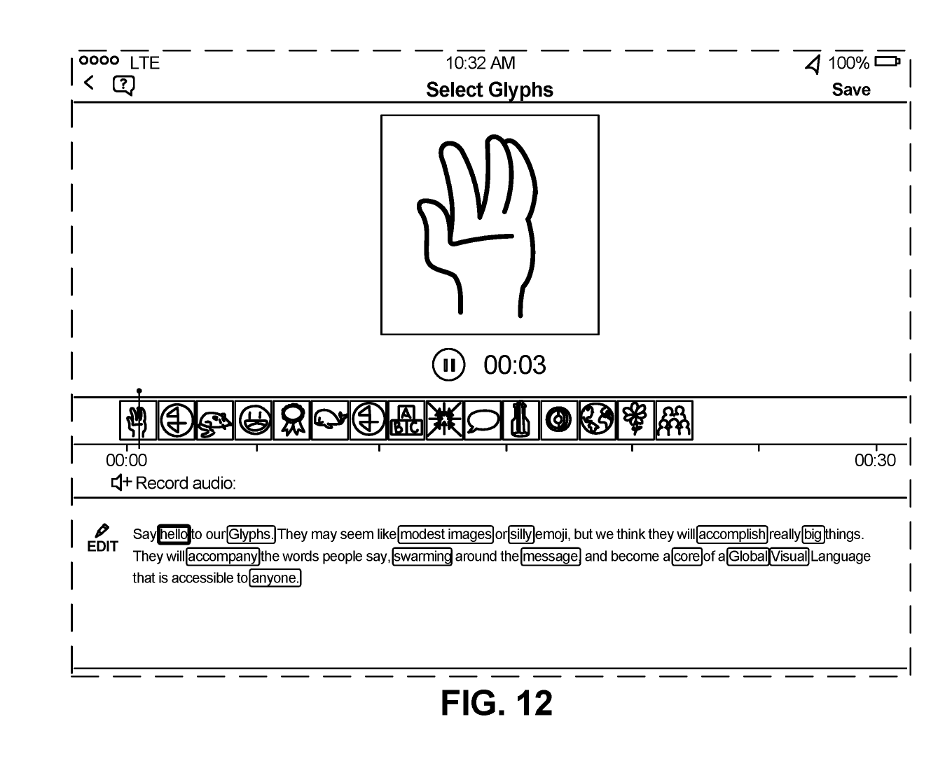

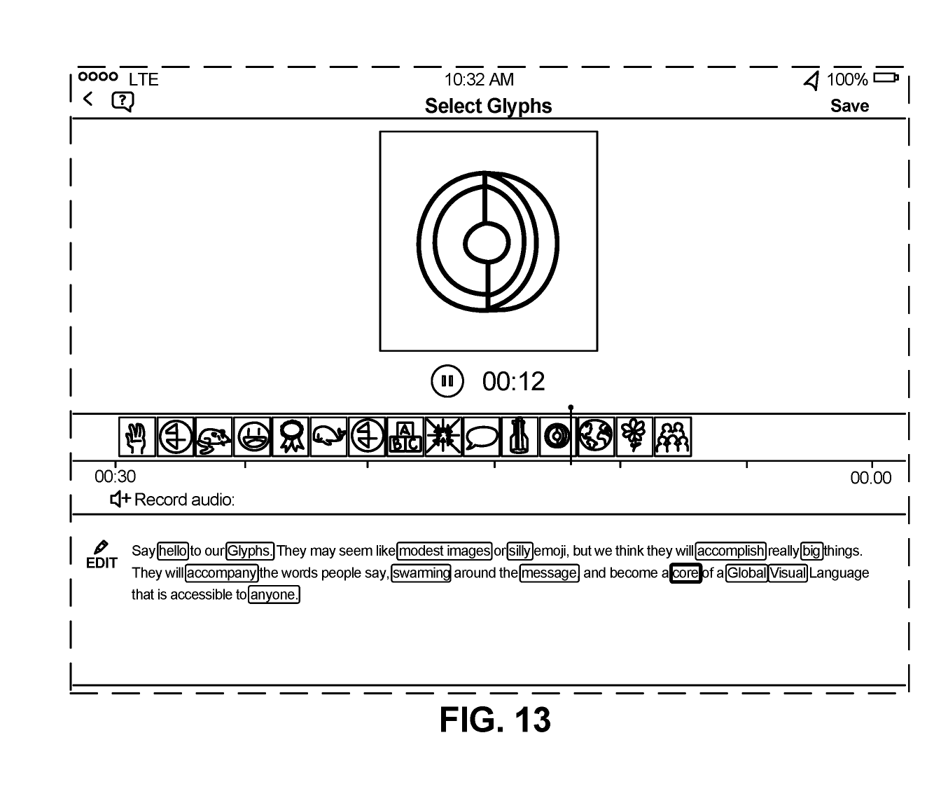

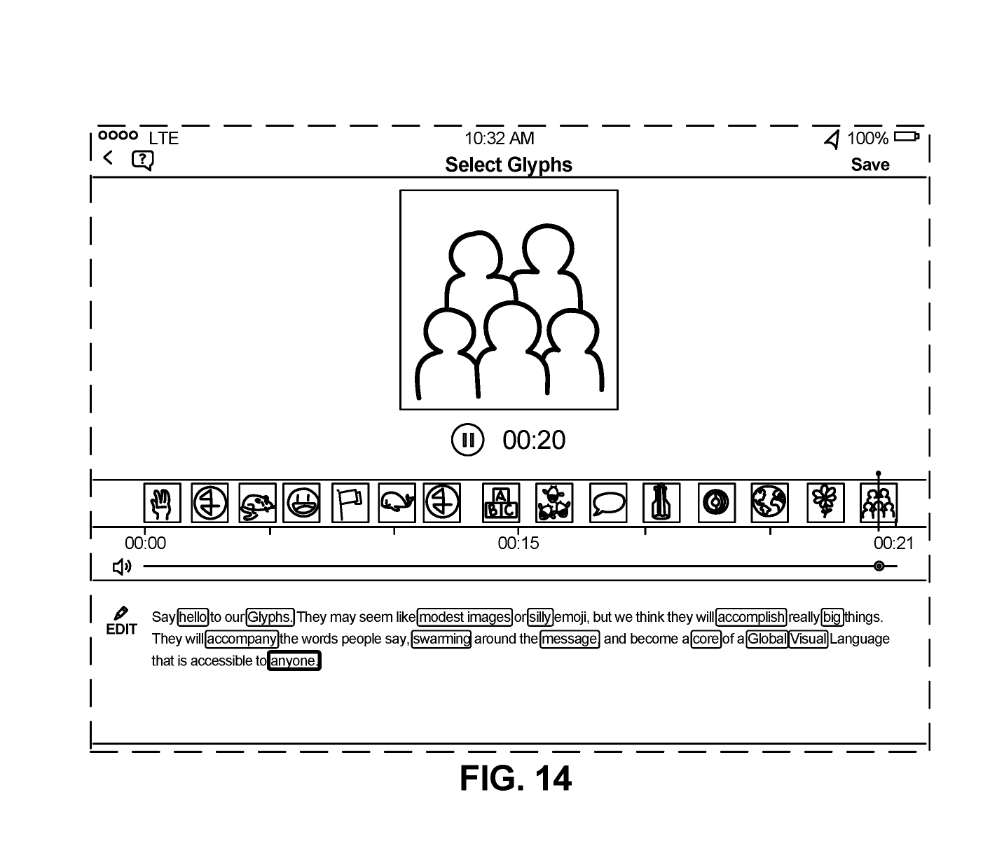

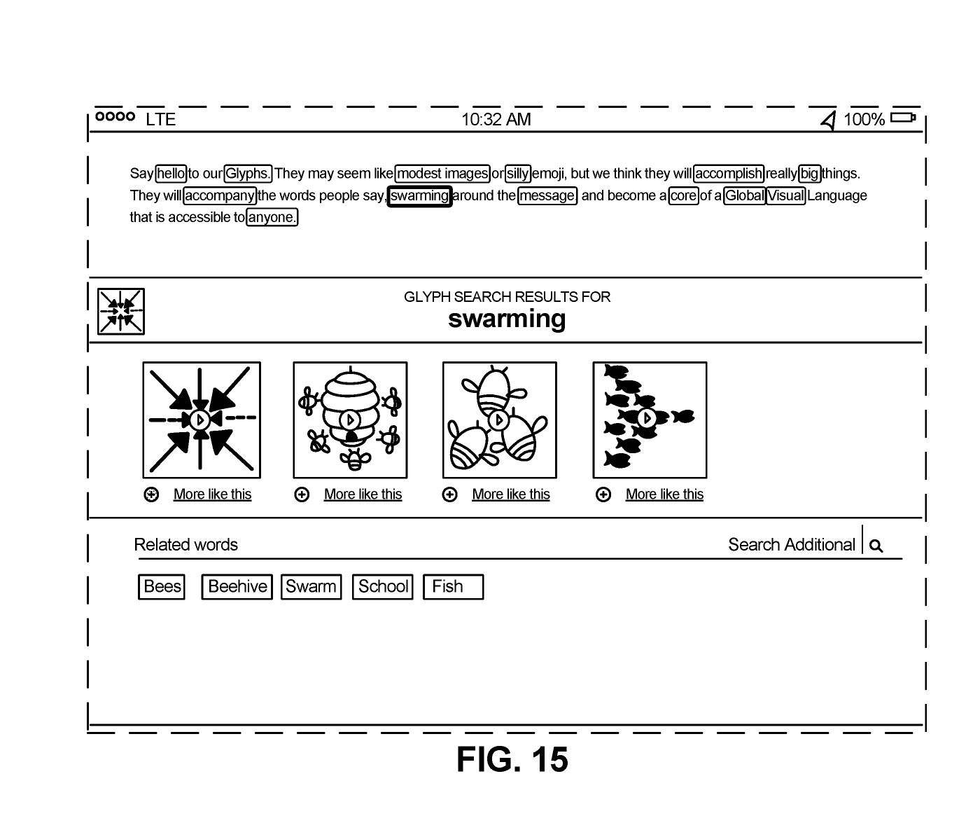

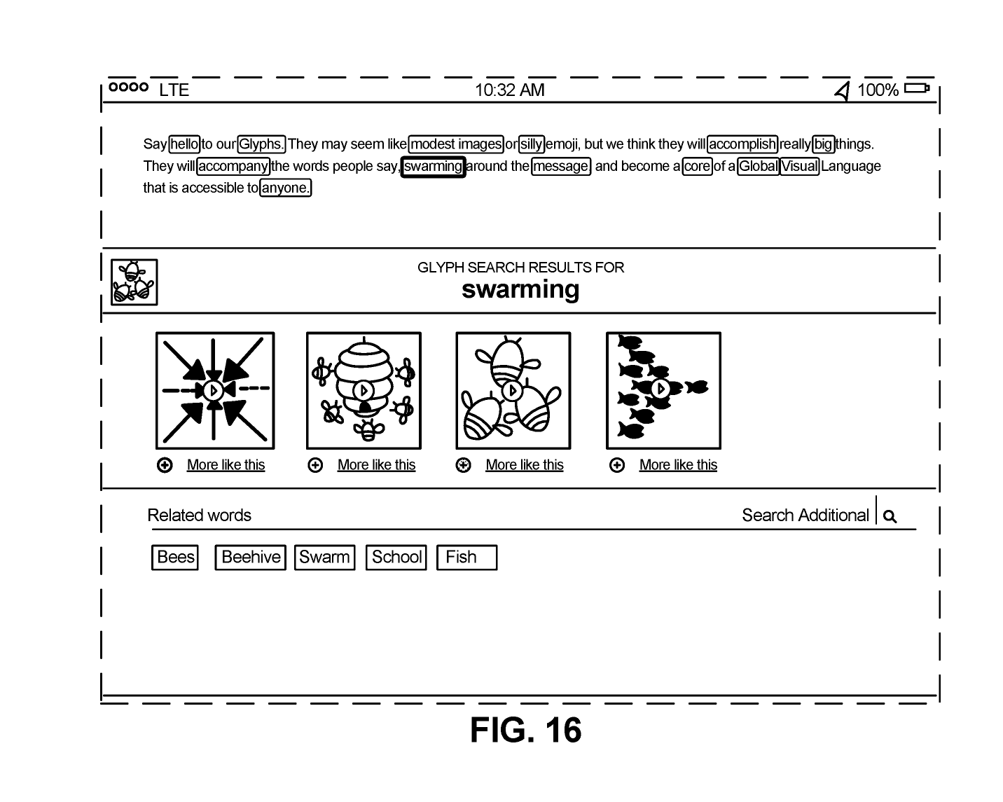

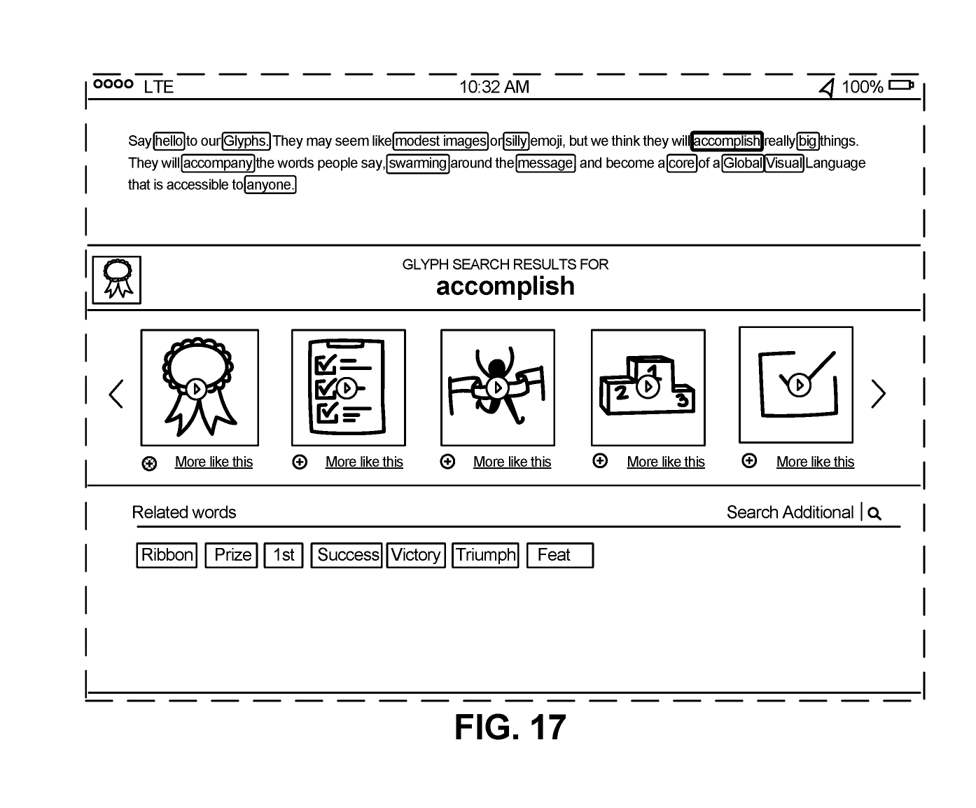

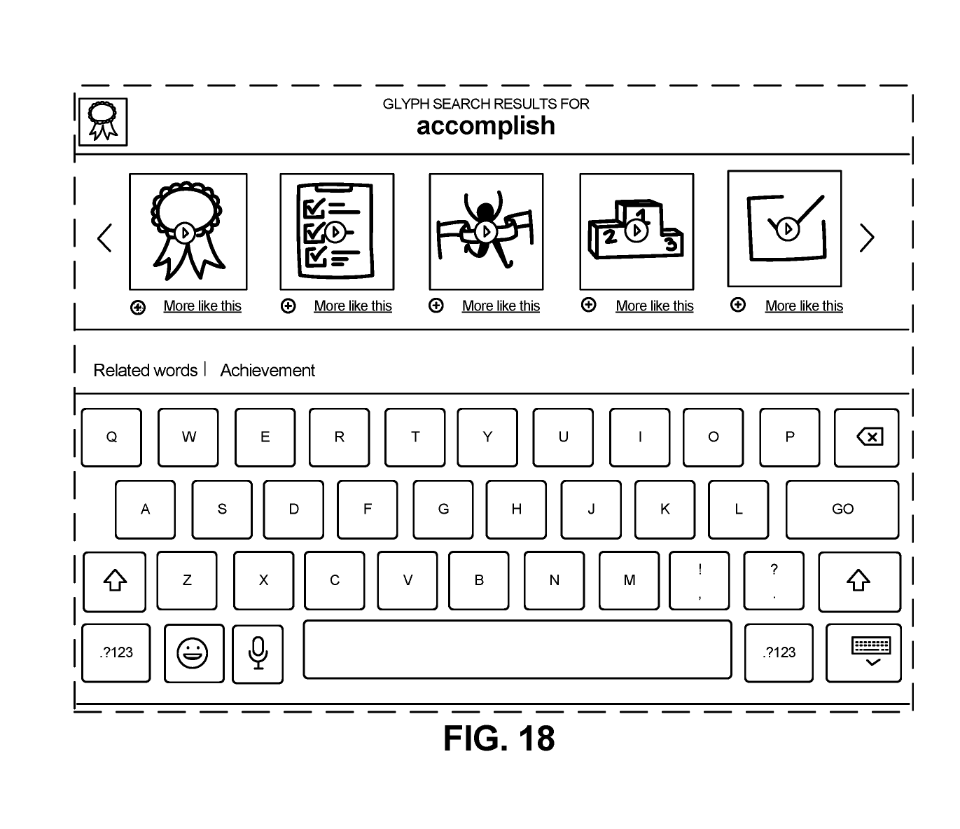

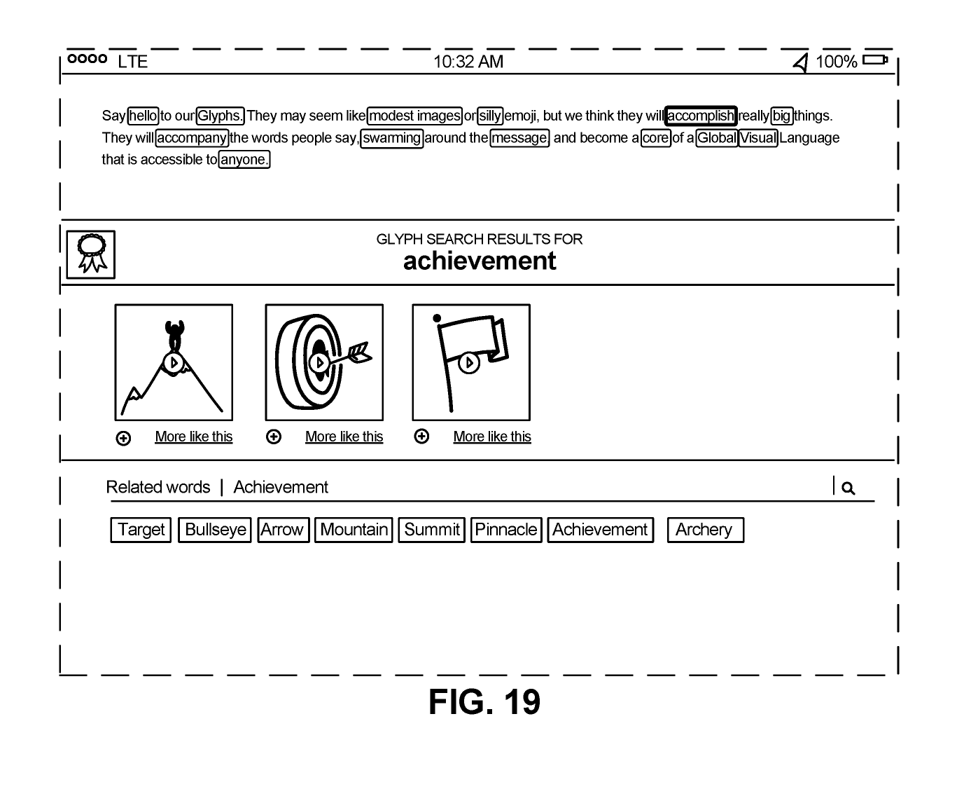

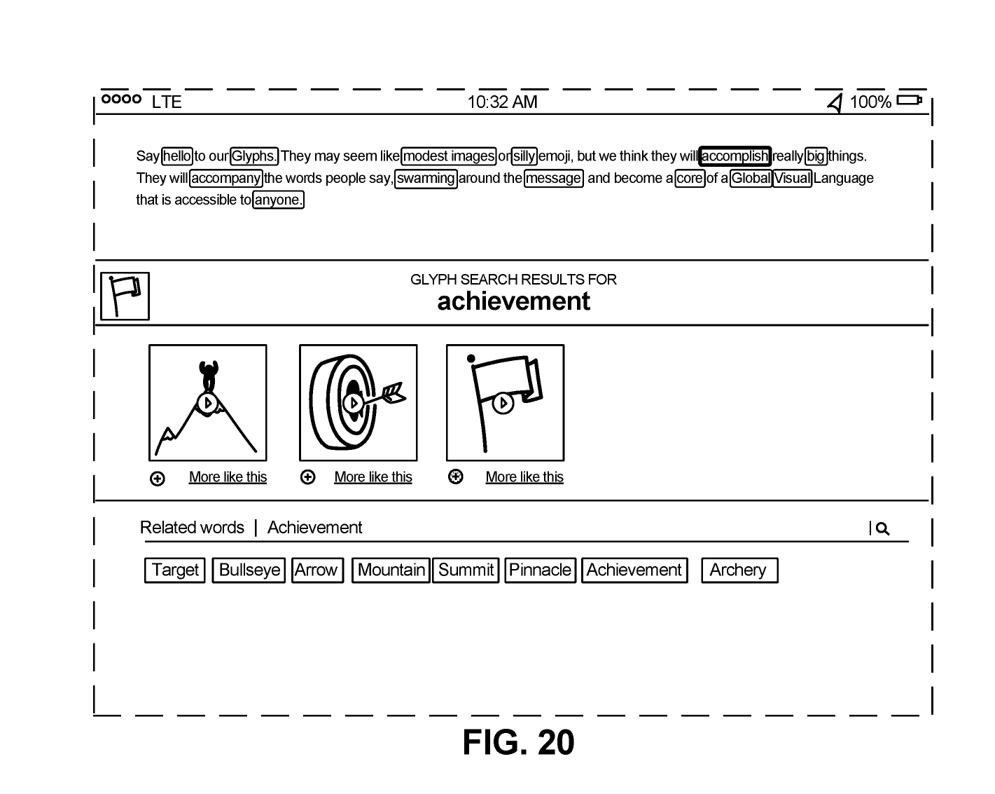

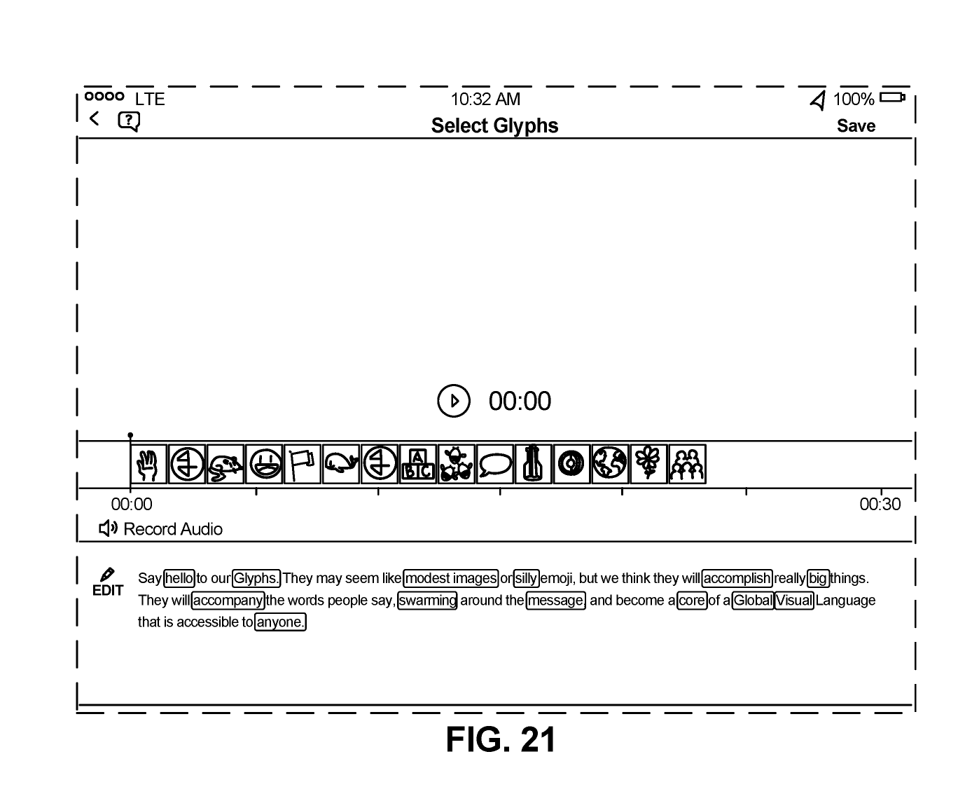

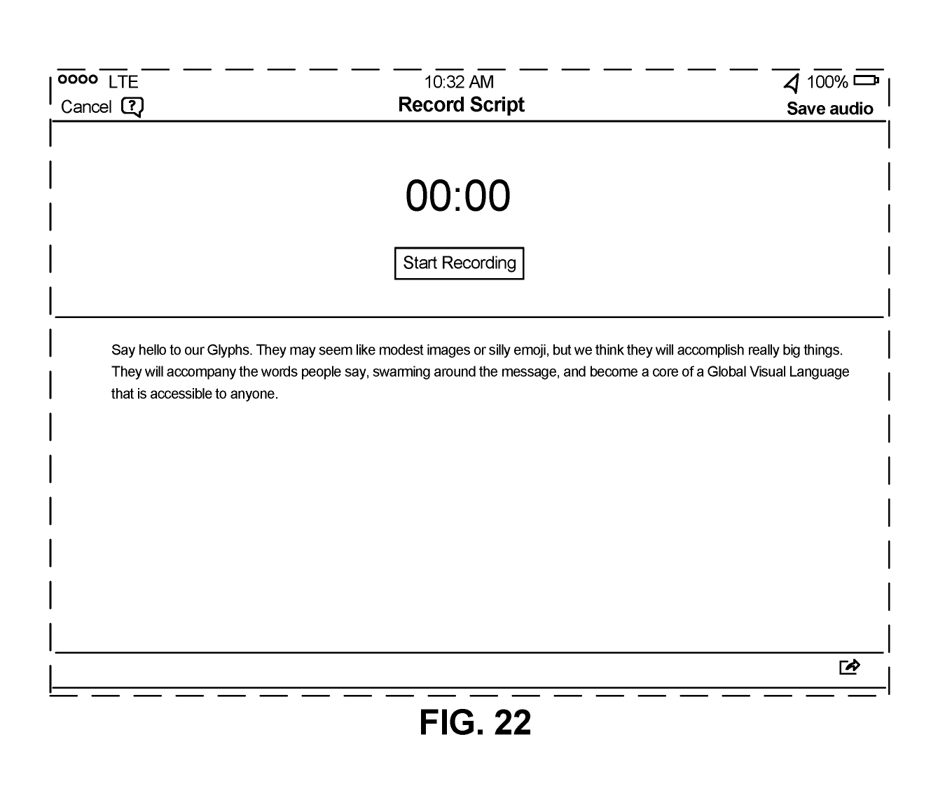

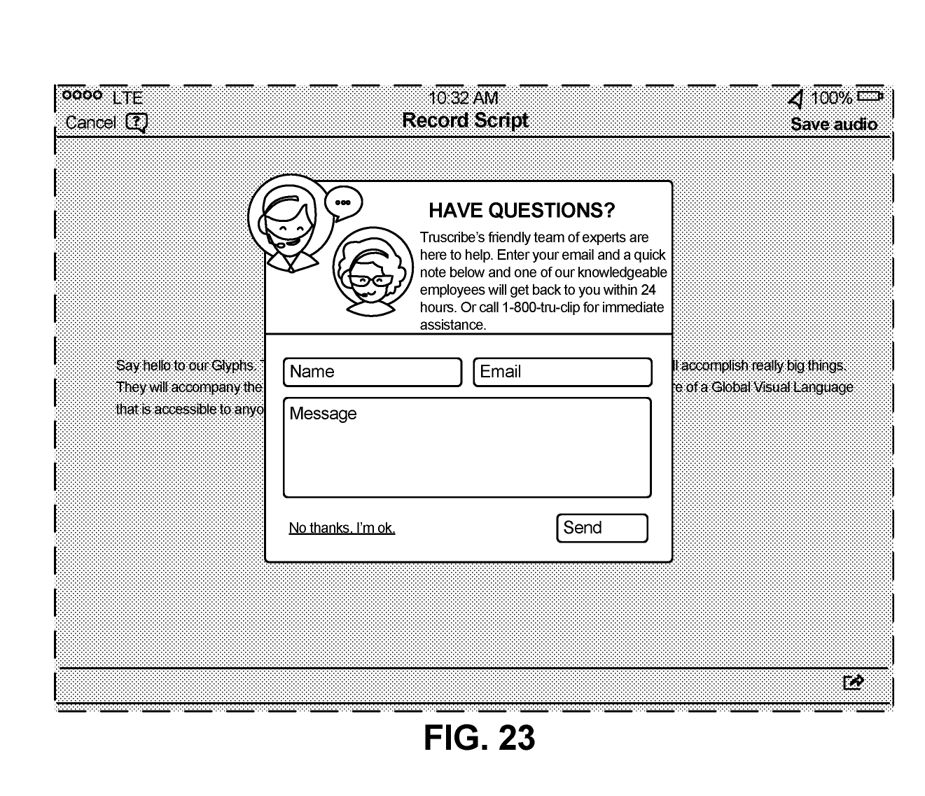

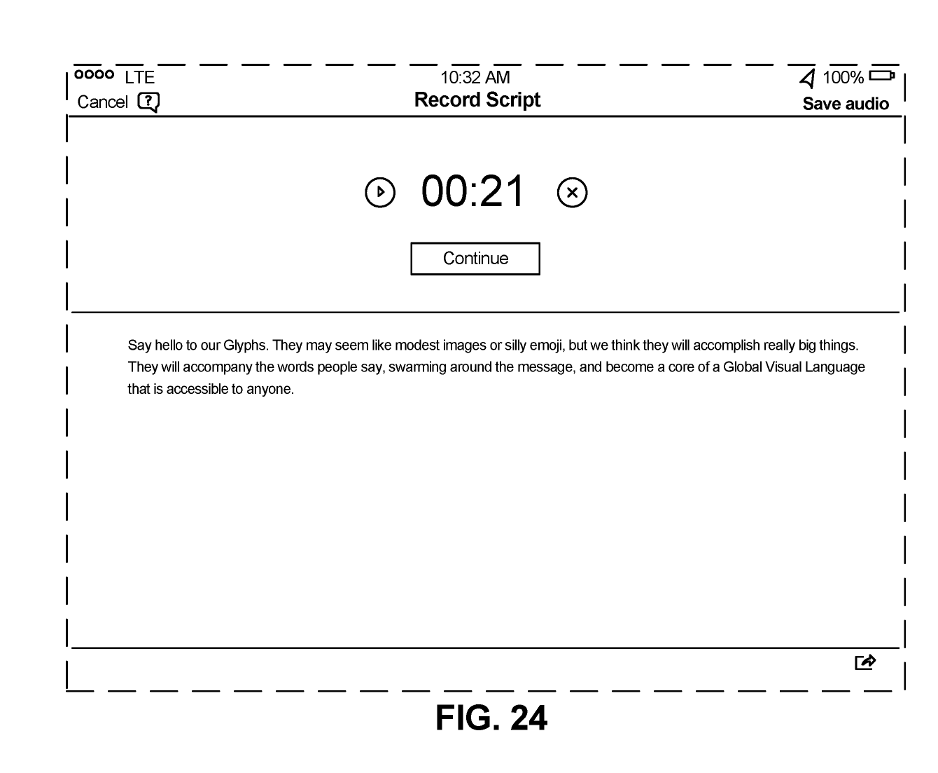

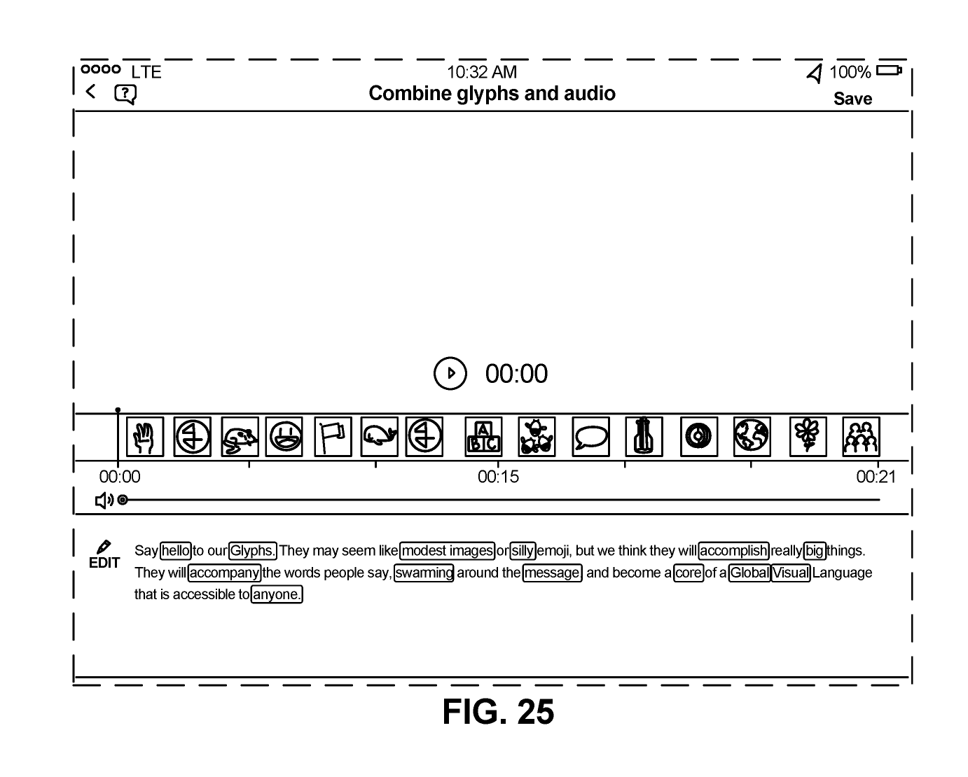

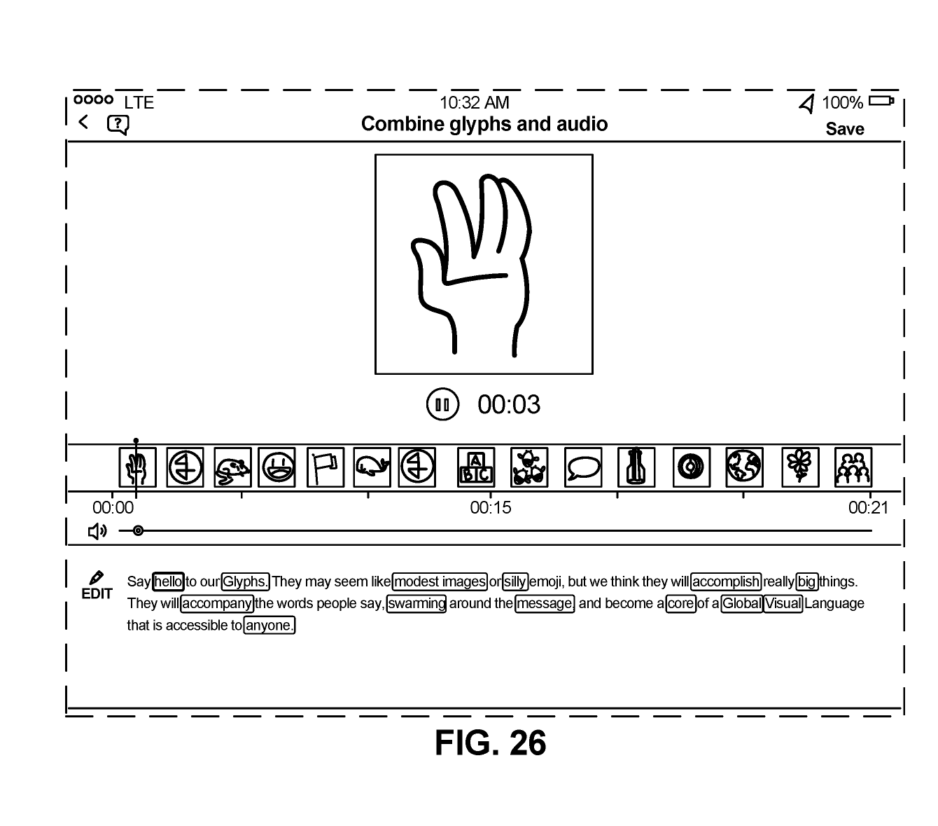

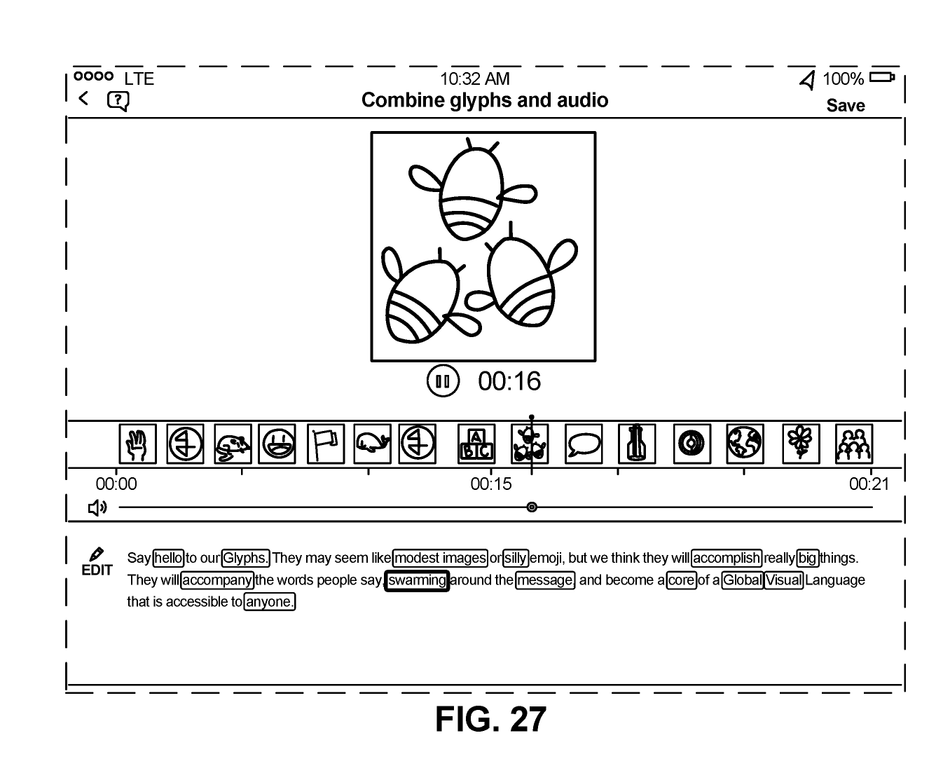

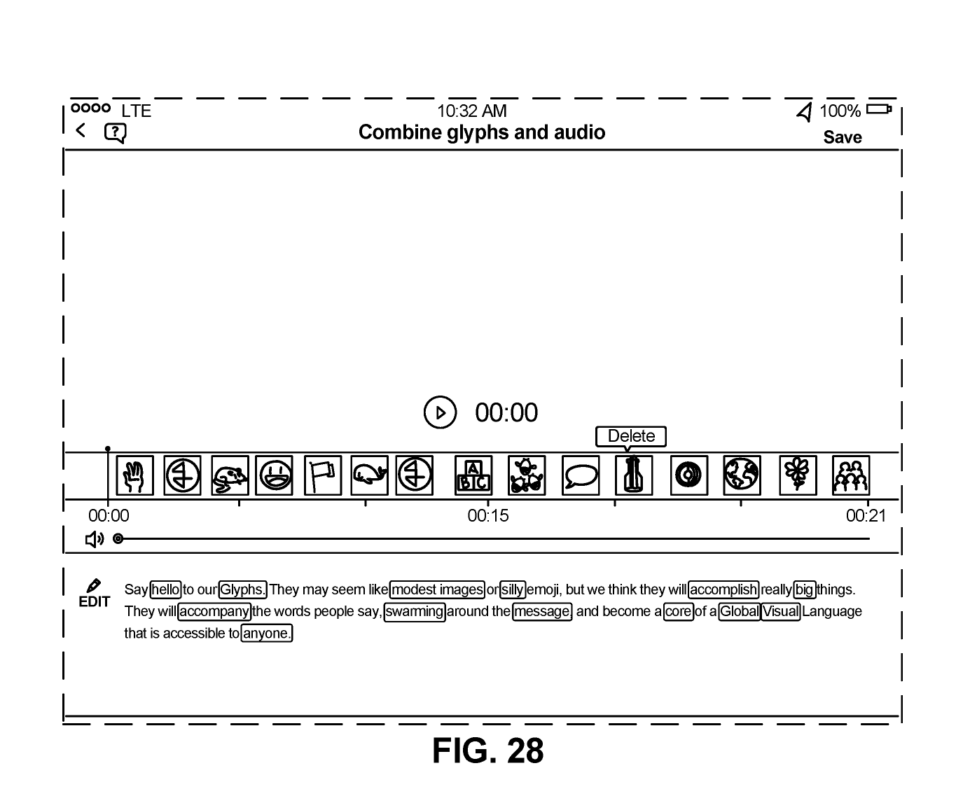

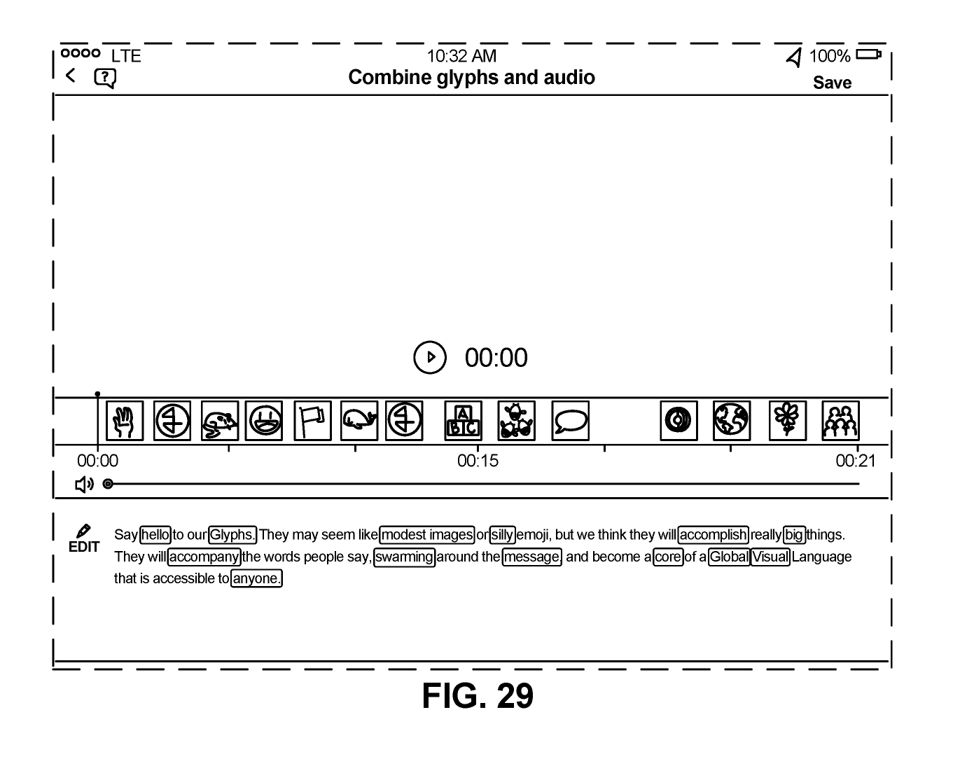

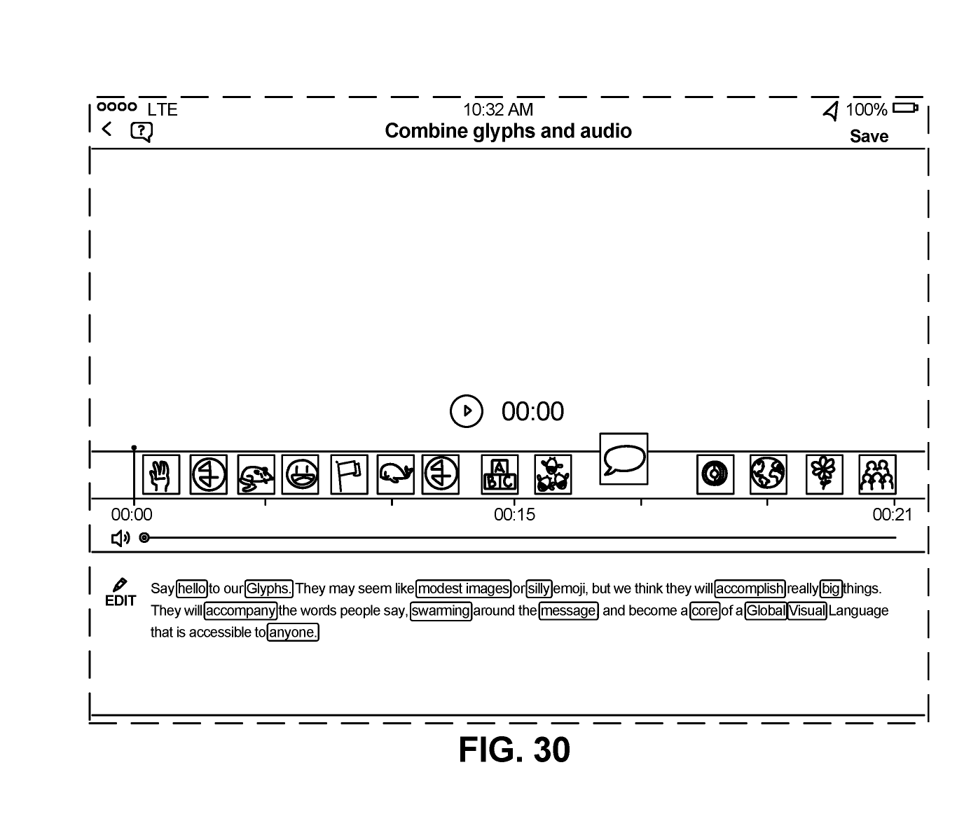

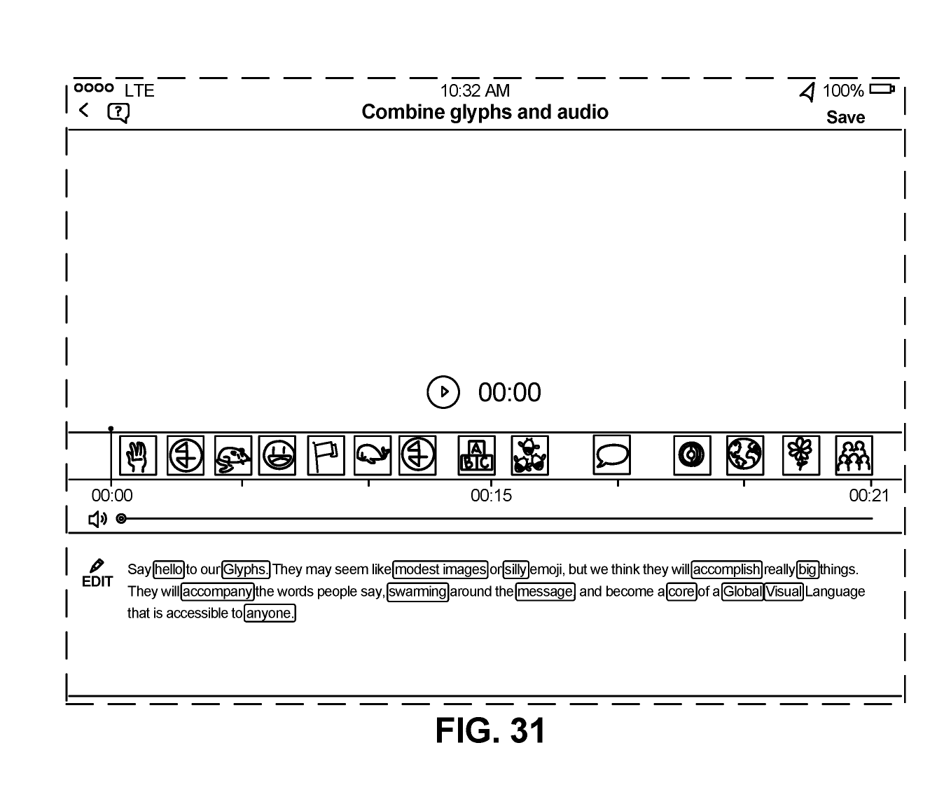

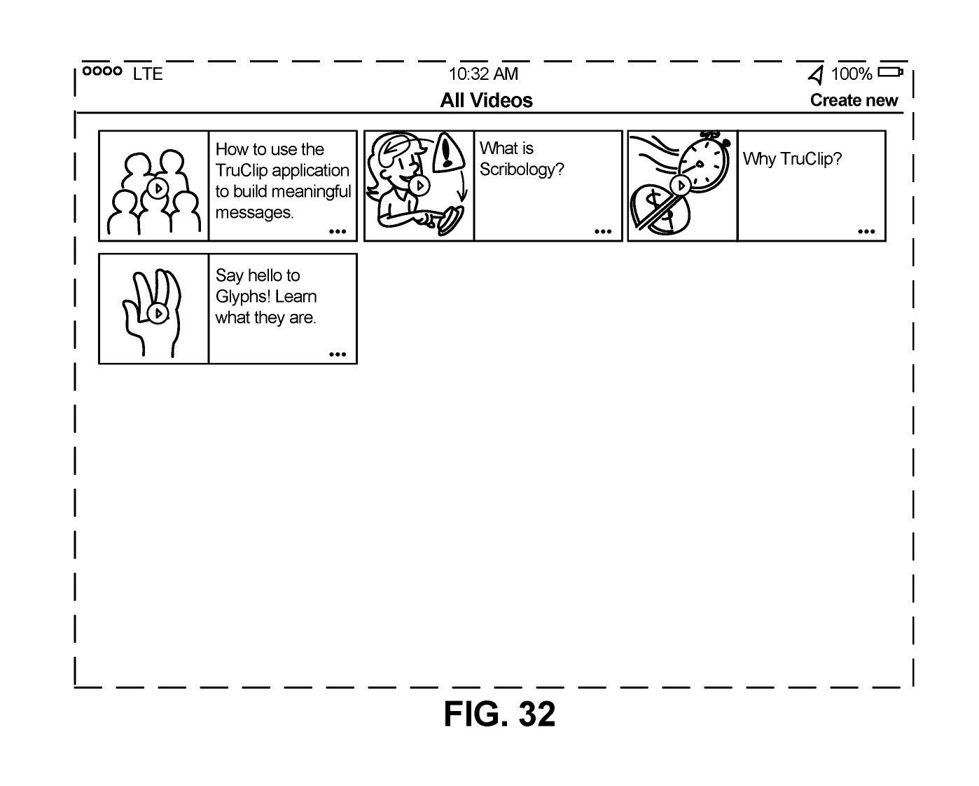

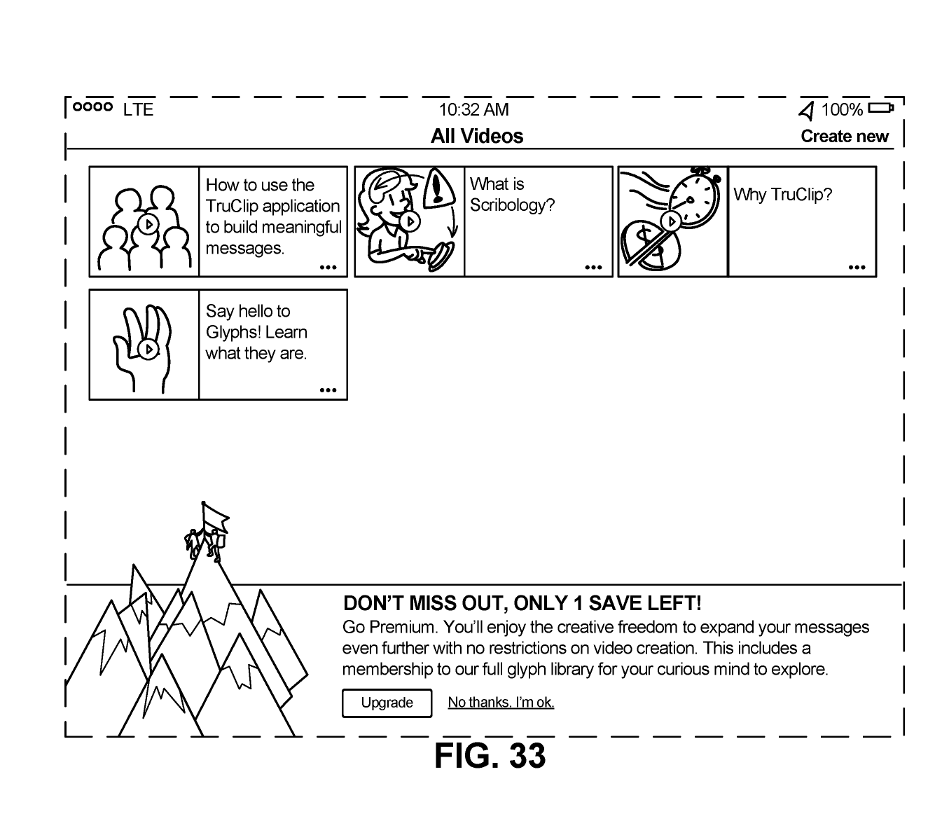

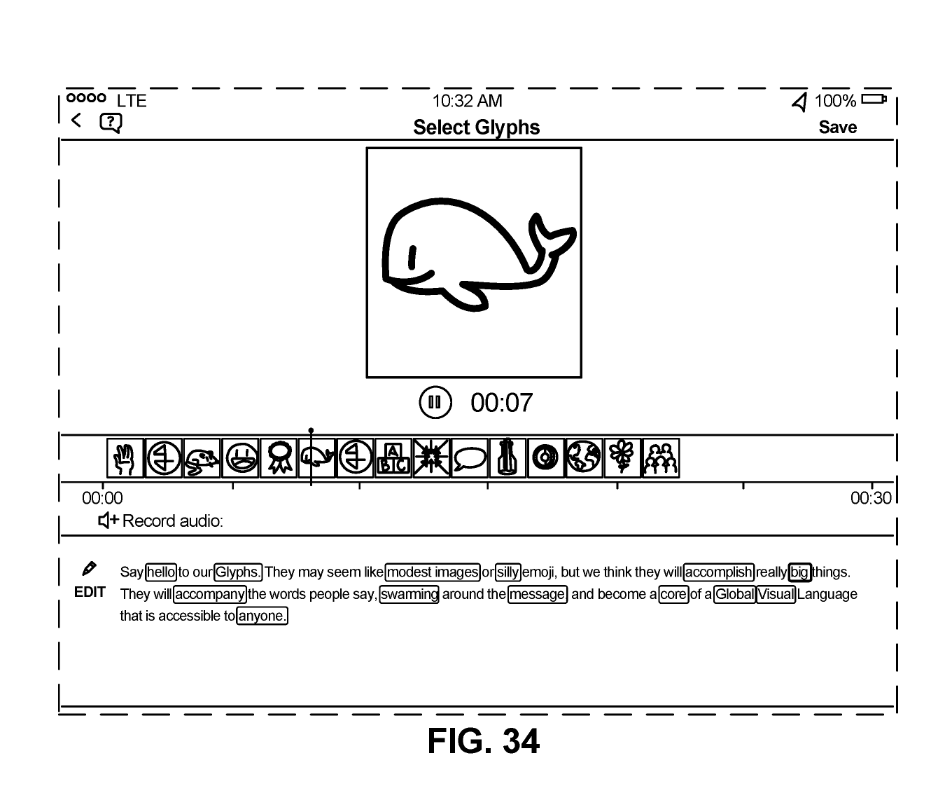

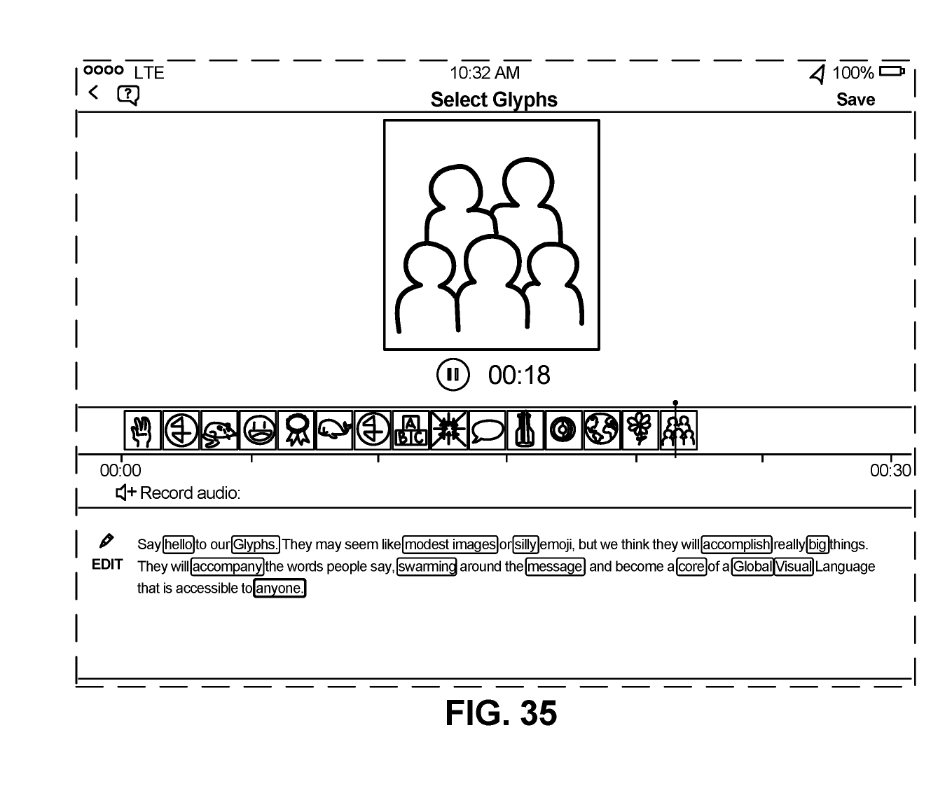

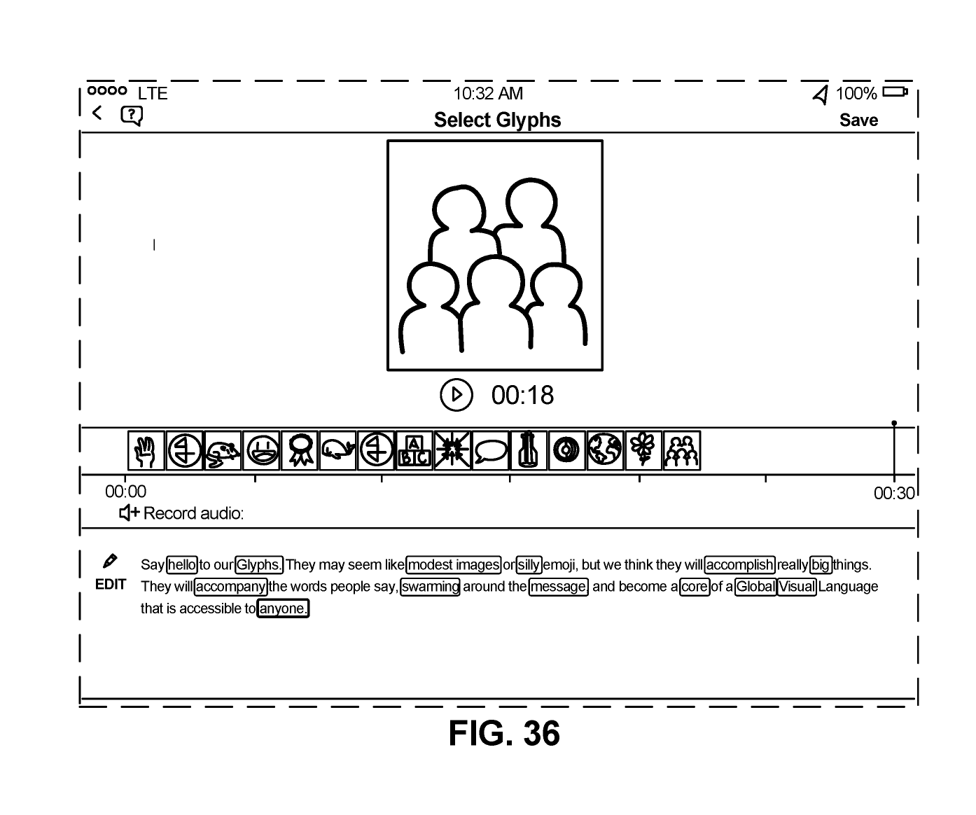

The user interface 302 may incorporate various data fields, buttons, tabs, pages, windows, and other interface elements known in the art. The user interface 302 may generally be configured for receiving information submitted by a user, such as text and audio inputs. The user interface 302 may generally allow a user to interact with the system 300. In some embodiments, a user may input a username and/or password at the user interface 302 to access the system 300. FIGS. 7-36 show various aspects of the user interface of some embodiments of the systems and methods of the present disclosure.

In some embodiments, users may be granted limited access to the system 300 through the user interface 302. Different types of users may have different access levels in some embodiments. For example, some access levels may be administrative access, creator/client access, and public access.

A user with administrative access may have viewing and editing capabilities for any databases, modules, processes, and whiteboard animation videos of the system 300. For example, a user with administrative access may have the ability to add, delete, modify, or reclassify glyphs in the glyph database 306. A user with administrative access may further have access to pending or completed whiteboard animation videos. For example, an administrative access user may have the ability to change inputs, such as intended audience or text, for a whiteboard animation video. In some embodiments, a user with administrative access may manually perform or edit the production process of a whiteboard animation video in the system 300. A user with administrative access may, for example, review and/or edit stories, keyword lists, glyph selections, and/or completed whiteboard animation videos to verify that the component is appropriate for its intended audience.

A user with creator/client access may have more limited access than a user with administrative access. A user with creator/client access may have viewing capabilities for at least some of the databases, modules, processes, and whiteboard animation videos of the system 300. For example, the user with creator/client access may have the ability to search databases of the system 300 and interact with modules and processes to create a whiteboard animation video. The creator/client access user may have editing capabilities for whiteboard animation videos created by the creator/client, and viewing capabilities for other videos on the system 300.

A user with public access may have more limited access than a user with creator/client access. A user with public access may have viewing capabilities for some databases or portions of databases of the system 300. For example, a user with public access may have the ability to view sample whiteboard animation videos that may be created with creator/client or administrative access.

In other embodiments, the administrative, creator/client, and public access levels may include additional or alternative capabilities. In still other embodiments, other access levels may be provided through the user interface 302.

As shown in FIG. 3, the user interface 302 and whiteboard animation module 304 may be in communication with one or more remote or local databases. For example, a glyph database 306 may store one or more glyphs that may be used in a whiteboard animation video. As discussed above, each glyph may be one or more animations, motions, or movements. Each glyph in the database 302 may be associated with one or more keywords in some embodiments. For example, a glyph depicting a hand drawing a rose may be coupled with keywords such as rose and flower. Other keywords may be applicable as well. In some embodiments, keywords may relate to an intended audience for the glyph, such as age, ethnicity, language, geographic location, or other aspects. Glyphs in the glyph database 306 may originate from any suitable source, and in some cases may be glyphs created by users.

In some embodiments, the system 300 may include one or more glyph databases 306 directed toward a particular targeted audience. For example, one glyph database 306 may store glyphs directed toward individuals located in India or of Indian descent, while another glyph database in the system 300 may include glyphs directed toward individuals in Japan or of Japanese descent.

The glyph database 306 may be public, partially public, or private. For example, a user may have a secured or privately accessible glyph database 306 having glyphs related to the user's particular needs that may not be available to any other users, or to only a limited number or group of other users. A secured or privately accessible database may restrict user access with a username and/or password or other access component. In some embodiments, a user may have access to multiple glyph databases 306, such as a private glyph database and a public glyph database.

In some embodiments, the user interface 302 and whiteboard animation module 304 may be in communication with one or more additional databases 308 such as a voice database. A voice database may be a database of human or computerized voices and/or other sounds that may be used when creating a whiteboard animation video. A user may have access to more than one voice database in some embodiments. A voice database or other database may be public, partially public, or private. A voice database may store voice or sound selections related to a particular location, language, or other parameter. The additional databases 308 may include any other suitable remote or local databases as well.

The glyph database 306 and one or more additional databases 308 may be searchable in some embodiments. The databases 306, 308 may be searchable by a user at the user interface 302 and/or by the whiteboard animation module 304. For example, the databases 306, 308 may be searchable by keyword or other parameters. In some embodiments, for example, a user may search the glyph database 306 by typing a keyword or keywords into a search box. The glyph database 306 may return a search result with glyphs associated with the searched keyword or similar keywords. The search result may be presented in a list or other format in order of closest match to the searched keyword or keywords. In other embodiments, the search result may be presented in any other suitable format. For example, the search result may be listed in order of most frequently used glyphs that also match or relate to the searched keyword. The format of the search result may be determined automatically or manually. For example, in some embodiments, a user may manually select an option to organize the search result by closest match to the searched keyword(s). In some embodiments, the user may be presented with a limited number of matches from the search result, such as three glyphs that best match the searched keyword for the particular use or the three glyphs that match the keyword and are also the most frequently used or highest ranked glyphs given the particular parameters of the specific video being created. The number of matches returned may be determined automatically or selected manually, or may be determined based on the access level of the user. In some embodiments, the user may have the option of narrowing the search result by selecting one or more parameters from one or more drop down menus. In other embodiments, the databases 206, 208 may be searched by any suitable search methods.

The whiteboard animation module 304 may be accessible via the user interface 302 and may allow a user to provide inputs to create a whiteboard animation video. As shown in FIG. 3, the whiteboard animation module 304 may have a video production engine 314 and an analytics engine 316. In some embodiments, the whiteboard animation module 304 may have additional or alternative components.

The video production engine 314 may provide for creation and production of a whiteboard animation video of the present disclosure. The video production engine 314 may have various tools, routines, and other components that allow a user to create a targeted and unique whiteboard animation video via, for example, the user interface 302. In some cases, the system will identify the appropriate number of keywords/glyphs that may be shown in a video of a given length. For example, a final video of three minutes may have a 160 word/per minute ration. The system will identify that ratio and define an ideal glyph per minute ratio to help users maximize the effectiveness of their message.

The analytics engine 316 may allow for reviewing the effectiveness or other results of one or more whiteboard animation videos created with the system 300. In some embodiments, the analytics engine 316 may collect and/or analyze a result or measure of effectiveness of a whiteboard animation video. For example, where a whiteboard animation video provides information needed by viewers to pass a test, such as a safety test, the viewers' test results may be collected and/or analyzed to determine effectiveness of the video. In other embodiments, other measures of effectiveness may be collected and or analyzed. Where it is determined that a whiteboard animation video is not as effective as anticipated or desired, the analytics engine 316 may remove, replace, or edit a particular element or component of the video, or additional material may be added to the video in some embodiments. For example, a particular glyph may be replaced to provide a more effective visual component. Some further examples of analytics provided by the system in some embodiments include, but are not limited to: how often a video was watched; where the video was paused; what sections were re-watched; who watched the video partially; who watched the video to completion; demographic analysis of test results; which individual or group had the highest test pass rate; which test sections were the easiest; which were the hardest; which test sections were the most difficult for which group of test takers; which team, group, or department had the highest success/fail rate, etc.

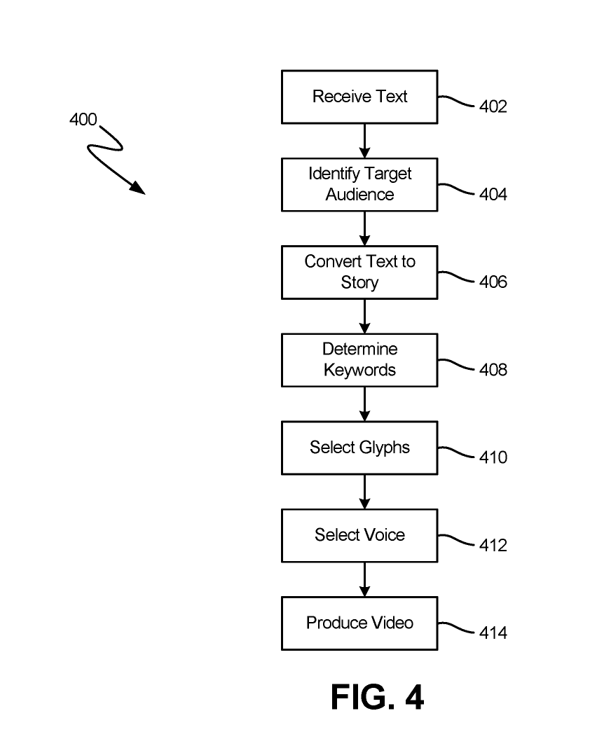

Turning now to FIG. 4, a method for creating a whiteboard animation video of the present disclosure is shown. The method 400 may include receiving and/or creating text 402, identifying a target audience 404, converting the text to a story 406, determining one or more keywords 408, selecting one or more glyphs 410, selecting a voice 412, and producing a video 414. The method 400 may be performed by a system of the present disclosure or by a user in conjunction with a system of the present disclosure.

In some embodiments, the method may include receiving text 402. The text may be received by the system 300 in some embodiments. The received text may be or include a message that the user wants to convey. A user may wish to convey various messages, such as for example, a holiday greeting, a welcome message, particular data or information, instructions, a thank you message, a congratulatory message, or generally any other information. The received text may, in some embodiments, be the particular words that a user wishes to convey. The text may be received from the user. For example, the user may input text in a text field at the user interface 302. The user may supply the text in response to a prompt in some embodiments. In other embodiments, the text may be received from other sources, such as from a database or a website. In some embodiments, the user may supply an audio file, from which the text may be extracted.

Method 400 may also include identifying a target audience 404. A target audience may be the one or more individuals or groups of individuals to which the user wishes to convey the message. For example, the target audience may be all employees, a select group of employees, new employees, or others. In other embodiments, a target audience may be students, patrons, subscribers, customers, or others. The target audience may generally be any individual or group of individuals to which the user wishes to convey the message. Identifying the target audience may include defining or identifying characteristics of the target audience, such as age, gender, ethnicity, geographic location, language, or other characteristics. The target audience may be identified by the user. For example, the user may be prompted at the user interface 302 to identify a target audience. In some embodiments, the user may select the target audience from a drop down list. In other embodiments, the system 300 may identify the target audience automatically or based at least in part on some user input.

The selection or determination of a target audience may generally allow the whiteboard animation video to be tailored or customized for the particular intended recipients of the message. For example, selection of a target audience may allow the system to tailor the text, story, glyphs, voice, and other elements to be culturally appropriate and culturally sensitive. Where the system or user determines that there are multiple target audiences, in some embodiments, a different whiteboard animation video may be created for each target audience. That is, the text, story, glyphs, voice, and other elements of the video may be tailored for each target audience, creating a tailored video for each audience.

In some embodiments, there may be multiple target audiences, or one target audience may be divided into multiple target audiences based on various factors. For example, where the target audience is all employees, and all employees include individuals throughout the world, a separate target audience may be identified for each region, country, city, branch, department, or other factor(s) representative of the employees. In some embodiments, a user may be prompted to determine whether there are multiple target audiences, or to divide the target audience if the system determines that the initially identified target audience includes a variety of audiences. In other embodiments, the system may automatically determine whether there are multiple audiences and/or the characteristics of those audiences, or may do so based on some user input. For example, in some embodiments, the system may automatically determine one or more target audiences based on known or previously selected user preferences. The target audience may be determined or selected before, during, or after production in various embodiments.

With continued reference to FIG. 4, the method 400 may include converting the received text to a story 406. A story may be or include a narration script of the message that the user wishes to convey. In some embodiments, the story may be the text as provided by the user. In other embodiments, converting the text to a story may include formatting the text. The story may include narration queues such as pacing queues, emphasis queues, or other narration queues. Where more than one target audience is identified, the text may be converted into multiple stories. For example, the text may be converted into a story for each target audience. The story for each target audience may differ based on cultural appropriateness, cultural sensitivities, languages, or other factors. In some embodiments, converting received text to a story may include translating the text into one or more languages. In some embodiments the translation may be performed by a third party entity; by machine translation; by machine translation reviewed/revised by a third party, etc. The system may use the identified keywords/glyphs to influence the translation, for example the importance of certain parts of the text or story.

Method 400 may further include determining one or more keywords 408, as described in greater detail above. A keyword may be a noun, verb, question, exclamation, number or other word or words related to the message that the user wishes to convey. In some embodiments, keywords may be pulled from the received text and/or the story automatically or partially automatically. For example, the system may search the received text and/or story for nouns, verbs, exclamations, questions, or other parameters. Where the system searches for keywords, the user may be provided with an opportunity to edit the list of retrieved keywords. In other embodiments, keywords may be provided by or identified by the user. The user may provide keywords in addition to the text or may, in some embodiments, highlight keywords within the text or story. Keywords may be used to select glyphs to associate with the whiteboard animation video in some embodiments. Additionally or alternatively, keywords may be words or phrases that may generally be highlighted or emphasized in the whiteboard animation video.

Method 400 may include selecting one or more glyphs 410. In some embodiments, one or more glyphs may be chosen by searching the glyph database 306 for the one or more keywords. For example, the system may search the glyph database 306 for a keyword. Where the search returns one or more matches for the keyword, the system may select the best match for a keyword. The best match may be determined based on the target audience, the story, user votes, or other parameters. In some embodiments, the system may present the user with multiple matches for a keyword from which the user may choose a glyph. In some embodiments, searching the glyph database 306 and selecting glyphs may be performed automatically or partially automatically by the system. In other embodiments, a user may search the glyph database using the keywords or other parameters.

Where multiple target audiences are determined, glyphs may be selected for each target audience. That is, for a particular keyword, a glyph may be different for one target audience than it is for a different target audience. In some embodiments, the glyphs particular to each target audience may be selected automatically or partially automatically. In some embodiments, a user may select or participate in the selection of glyphs for one target audience, and the system may automatically select appropriate glyphs for additional target audiences. In other embodiments, a user may select or participate in the selection of appropriate glyphs for each target audience.

Method 400 may further include selecting a voice 412. In some embodiments, a voice may audibly read all or portions of the story in the whiteboard animation video. In some embodiments, the voice may be selected from a voice database or may be imported from another source. The voice may be selected automatically or partially automatically by system. The voice selection may be based on the target audience, keywords, or other parameters. In some embodiments, the user may select a voice from the voice database. In other embodiments, the user may upload a voice, such as his or her own voice. For example, the user may upload a sound file of the user reading the story. In other embodiments, the user or system may select or upload a voice from any suitable source. Where multiple target audiences are determined, a voice may be selected for each target audience.

With continued reference to FIG. 4, the method 400 may include producing a video 414. Producing a video may include combining the story, glyphs, and voice into a whiteboard animation video. Production of the whiteboard animation video may include aligning the selected glyphs with each of the selected keywords associated with the story, and coupling the selected voice to the story. For example, production may include an audio track of the selected voice reading the story along with a visual presentation of the selected glyphs, such that as each keyword associated with a glyph is read by the selected voice, the appropriate glyph may simultaneously be presented visually. In some embodiments, production may include adding text or other visuals or sounds to the whiteboard animation video. While the production may result in a whiteboard animation video complete with sound, text, and glyphs, the output of the method may generally include multiple elements in some embodiments. For example, an audio file of the selected voice reading the story, the collection of selected glyphs, the video of the glyphs displayed, the story text, metadata, and any other elements of the finished whiteboard animation video may each be saved, sent, or otherwise separated out as individual components.

Production of the whiteboard animation video may further include a determination of timing and pacing for the voice and presentation of glyphs and text. For example, pacing may depend, at least in part, on how many glyphs are included in the video. Multiple glyphs drawn consecutively may require slowed voice pacing or the introduction of pauses between certain clauses or sentences, for example.

In some embodiments, a user may have the opportunity to make adjustments to the whiteboard animation video during or after production. For example, the user may replace one or more glyphs, select a different voice, make alterations to the story, or make alterations to any text that is presented in the video. A user may additionally or alternatively make alterations to the speed or pacing of the whiteboard animation video. In other embodiments, a user may make other changes to the video before, during, or after production.

Where more than one target audience is determined, the production step may include producing multiple whiteboard animation videos. That is, the production may include combining a story, glyphs, and sound into a whiteboard animation video for each target audience.

As described, the systems and methods of the present disclosure may provide for the creation of culturally appropriate, culturally unique, and culturally sensitive whiteboard animation videos. It may be appreciated that the systems and methods of the present disclosure may allow a user to generally input the text to be used for a message once, and the systems and methods may create one or more unique whiteboard animation videos tailored to one or more target audiences. In this way, a user may create a narrow and focused message for one or more unique target audiences with minimal user input. The systems and methods may automatically select or assist the user to manually select language, wording, voice, glyphs, and other choices that are appropriate for one or more particular target audiences.

The systems and methods of the present disclosure may provide for effective, and where applicable worldwide, targeted messaging. For example, an executive of a large, global company may wish to send a message to all employees. The message may include a year-end summary for the company, for example, along with a holiday greeting. Using conventional messaging platforms, the executive may send a recorded video, Power Point presentation, e-mail, or other message type. However, the message would need to be translated into each appropriate language, which may add to the time needed for creating the global message. In addition, the message may not include culturally sensitive language or phrasing in some cases, because a direct translation may not provide such culturally appropriate components. Moreover, conventional messaging formats such as e-mail, Power Point, or other formats may not provide for particularly effective or engaging communication where a broad audience is being targeted. In contrast, the systems and methods of the present disclosure may allow for the creation of one or more narrow, focused, and culturally sensitive messages. In the above example, the executive could input the message into a system of the present disclosure in order to create a unique and effective, culturally appropriate message for each individual targeted audience of the worldwide employee base.

Furthermore, the systems and methods of the present disclosure may provide for editing and reusing individual elements of a whiteboard animation video. Specifically, in some embodiments, a whiteboard animation video may be maintained as individual components or elements, which allows at least in part for the scalability of the systems and methods of the present disclosure. For example, individual glyphs used in the animation video may be maintained as separate elements or separate files in some embodiments. In this way, the individual glyphs may be saved, stored, reused, edited, removed, or replaced, even after a video has already been completed. Similarly, the voice and story may each be maintained as one or more separate elements, such that each element may be saved, stored, used, edited, removed, or replaced. For example, a user may decide to reuse a video created previously. The user may wish to update particular information contained within the video. In some embodiments, the user may select particular elements of the video to be edited, removed, or replaced. The user may additionally add material to the video. Individually maintained elements may also allow the target audience of a video to be changed. That is, for example, a video created for a particular target audience may be converted for use with a different target audience by editing, removing, or replacing particular individual elements within the video such as particular glyphs.

Similarly, where individual components or elements of a whiteboard animation video are maintained separately, the individual elements or components may be reused. For example, a user may wish to create a new animation video using elements from previously created animation videos. In some embodiments, a particular glyph, set of glyphs, voice, story, portion of a story, or other element may be extracted or copied from a whiteboard animation video to be reused, such as in a new whiteboard animation video. A user may reuse elements from animation videos previously created by the user or the user's company or others.

The one or more databases of the present disclosure may include small elements provided by the system and/or users or others that may be combined together by future users to create a final video quickly and cost-effectively. More about storing separately.

Glyph Creation

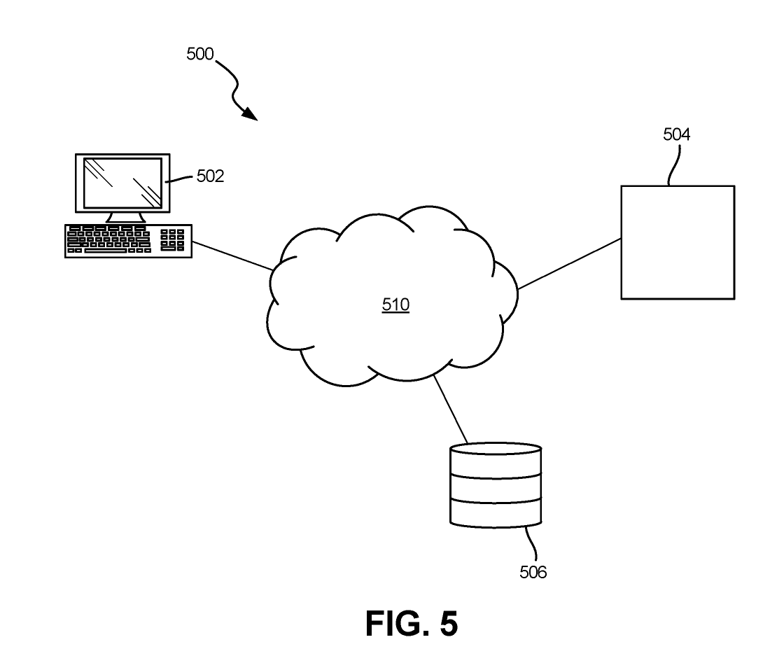

Turning now to FIG. 5, a system 500 for creating a glyph may also be included in some systems of the present disclosure. The glyph database may include glyphs provided by the system and/or glyphs created by the user and submitted to the system, and/or glyphs created by users of the system's glyph creation module. The system's user glyph creation application may include a user interface 502, a glyph creation module 504, and a glyph database 506 connected over a wired or wireless network 510. The glyph creation system 500 may generally allow a user to create a new glyph or modify an existing glyph. The newly created or modified glyph may be added to the glyph database 506 such that it may be used in the creation of a whiteboard animation video. In some embodiments, the components of the glyph creation system 500 may be integrated with or operate in conjunction with a system of the present disclosure for creating whiteboard animation videos. In other embodiments, system 500 may be a separate system.

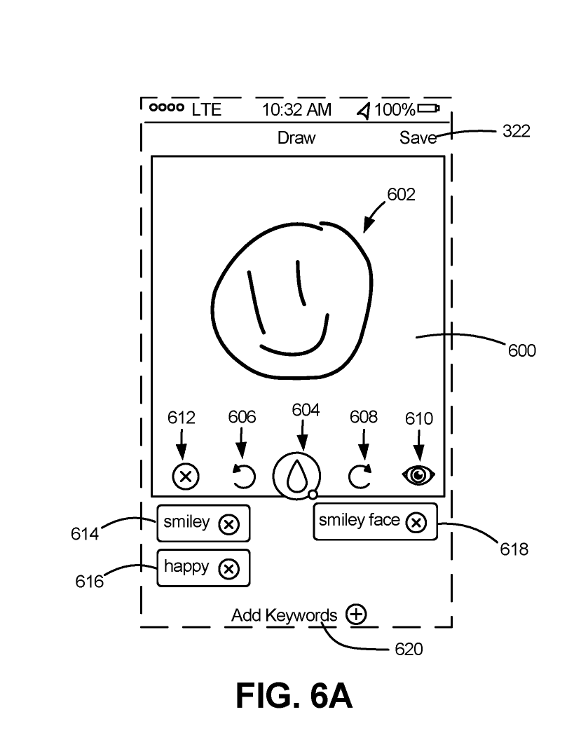

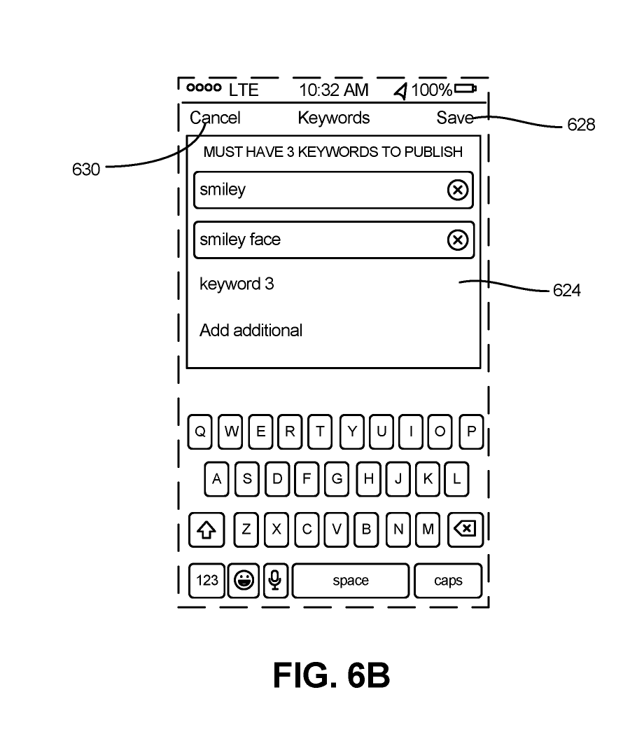

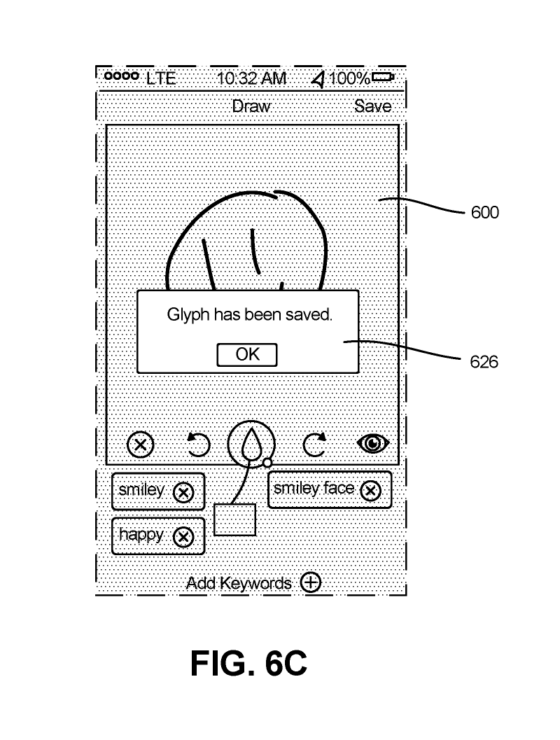

The user interface 502 may allow a user to access and generally interact with the glyph creation module 504. The user interface 502, in at least one embodiment, is shown in FIGS. 6A-6C. As shown in FIGS. 6A-6C, the user interface 502 may be a smartphone application-based user interface. In other embodiments, the user interface 502 may be provided over a desktop computer, notebook computer, tablet, PDA, or other computing device. The user interface 502 may be an application or web-based user interface. As shown in FIG. 6A, the user interface 502 may have a draw space 600 in which a user may draw or record a glyph 602. As discussed previously, a glyph 602 may include not only the image drawn, but also the motion used to create the image. A user may draw within the draw space 600 using a digital pen tool to draw a line, curve, text, or combination thereof. In other embodiments, the user may draw on a screen with his or her finger or may use a stylus or mouse pointer to draw the line, curve, text, or combinations thereof. In other embodiments a user may use voice-directed drawing.

The user interface 502 may include a record button 604. A user may press the record button 604 to start recording the drawing of the glyph 602, and press the record button again to stop the recording. In some embodiments, the user may start and stop the recording multiple times, for example, to make adjustments or changes while drawing the glyph 602. In some embodiments, a user may have a limited amount of recording time in which to draw the glyph 602. In some embodiments, a user may additionally or alternatively have a limited amount of digital ink with which to draw a glyph 602. In some embodiments, the time limit and/or digital ink limit may be represented in the draw space 600, and in some embodiments as part of the record button 604, as shown in FIG. 6A. The user may be alerted when the time limit and/or ink limit are reached. In some embodiments, a digital ink pot 605 may represent the amount of digital ink with which a user may draw a glyph 602. The digital ink pot 605 may illustrate the amount of ink remaining while the user is recording the glyph 602. In this way, the size and/or complexity of user created glyphs may be controlled.

The draw space 600 may have one or more additional buttons, such as an undo button 606, a redo button 608, a preview button 610, and a delete button 612. In other embodiments, the draw space 600 may have alternative or additional buttons or other functionality or tools. The undo button 606 may allow a user to undo a previously recorded or drawn segment or element. Likewise, the redo button 608 may redraw a previously recorded or drawn segment or element. The preview button 610 may allow a user to preview the recording of the glyph 602, for example as it will appear when saved to the glyph database 506. The delete button 612 may allow a user to delete the glyph 602 or a portion of the glyph. In some embodiments, the user may have the option to choose different ink colors and writing utensil styles and sizes.

In some embodiments, an add keywords 620 button may allow the user may assign one or more keywords 614, 616, 618 to the glyph 602. Pressing the add keywords button 620 may, in some embodiments, open a different screen, as shown in FIG. 6B. The add keywords space 624 may have one or more fields where a user may type a keyword to be associated with the glyph 602. In some embodiments, a user may be required to assign a minimum or maximum number of keywords to a glyph 602 before the glyph may be saved. Once the user has entered a desired number of keywords, the user may return to the draw space 600 by pressing a done button 628, cancel button 630, or other button.

A save button 622 may allow a user to save a recorded glyph 602 to a location such as to the glyph database 506. Pressing the save button 622 may bring the user to a different screen or may display a popup window 626, as shown in FIG. 6C to alert the user that the glyph has been saved.

With reference to FIG. 5, the glyph creation module 504 may have various tools, routines, engines, and other components that allow a user to create or edit a glyph for use in a whiteboard animation video via, for example, the user interface 502. As described above, a user may draw or record a new glyph using the user interface 502. The glyph creation module 504 may also allow a user to pull an existing glyph from the glyph database 506 for editing. For example, a user may modify the direction of a particular motion or may add or remove a motion in the existing glyph. In some embodiments, the glyph creation module 504 may add an image, video, or animation of a pen or a hand holding a pen to the glyph created or modified by the user, such that when the glyph plays, it appears as though the pen and/or hand are drawing the image. The glyph creation module 504 may store the newly created or modified glyph in the glyph database 506.

The glyph database 506 may include glyphs created by users, edited by users, and/or glyphs from other sources. The glyph database 506 may be accessible by other users or modules for creating a whiteboard animation video. In some embodiments, the glyph database 506 may be or include attributes similar to those discussed above with respect to glyph database 306. Glyphs in the glyph database 506 may be associated with one or more searchable keywords. Where a glyph in the database 506 was created by or edited by a user, the glyph may be associated with the user's name, profile, or other information about the user. In this way, others who choose to use the created or modified glyph may view who created or modified the glyph. In some embodiments, the glyph database 506 may be searchable by creator or modifier name or other creator or modifier parameters. The creator or modifier of the glyph may in turn receive a notification when their glyph is viewed or selected for use in a whiteboard animation video.

In some embodiments, the glyph database 506 may include a voting function accessible via the user interface 502. The voting function may allow a user to rate, like, favorite, promote, or otherwise vote for one or more glyphs in the database 506. Glyphs may be ranked or rated in the database 506 based on user voting. In some embodiments, a search of the glyph database 506 may be limited by or organized based on user voting. For example, the highest ranked or most liked glyphs matching the particular search parameter(s) may be presented in a search result.

It may be appreciated that the voting function may provide for an evolving glyph database 506 that responds to trends by allowing users to signify popular glyphs. The voting function may be location, audience, and/or language specific in some embodiments. In this way, the glyph database 506 may reflect location, audience, and/or language specific trends. In other embodiments, the voting function may be limited or based on other parameters. Categories that may be available for user to vote on could include, but are not limited to: ornithology, business, health, money, legal, animals, science, arts, entertainment, sports, food, geography, etc.

In some embodiments, one or more incentives may encourage users to create glyphs to add to the glyph database 506. For example, prizes, scholarships, contests, or other incentives may be offered to users in exchange for creating one or a number of glyphs to add to be added to the glyph database 506. In some embodiments, there may be limitations on the types of glyphs that may be created in order to qualify for the incentives. The incentives may be offered through the glyph creation module 504 or through other means.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

Although the present invention has been described with reference to preferred embodiments, workers skilled in the art will recognize that changes may be made in form and detail without departing from the spirit and scope of the invention.

1. A method for creating a whiteboard animation video having glyphs and voice, the method comprising:
determining an intended audience for the video;
receiving text comprising information to be conveyed by the video;
converting the text to a story comprising a narration to be provided in the video;
determining one or more keywords from the story;
assigning one or more glyphs to each keyword;
determining a voice for narrating the story; and
producing the video.

2. A system for creating a whiteboard animation video having glyphs and voice, the system comprising:
a user interface;
a whiteboard animation module accessible at the user interface and configured for receiving inputs from the user interface; and
a glyph database storing one or more glyphs for use in whiteboard animation videos.
